(19) United States
(12) Patent Application Publication
(10) Pub. No.: US 2026/0057255 A1
(43) Pub. Date: Feb. 26, 2026

(54) Signalless Internet using Super intelligent robots and the A.I. Gnosis timeline

(71) Applicant: Mitchell Kwok, Honolulu, HI (US)

(72) Inventor: Mitchell Kwok, Honolulu, HI (US)

(21) Appl. No.: 18/814,493

(22) Filed: Aug. 24, 2024

(51) Int. Cl. G06N 5/022; H04W 40/24; H04W 84/06

(52) U.S. Cl. CPC G06N 5/022; H04W 40/246; H04W 84/06

(57) ABSTRACT

A method to create a 100% signalless internet that uses equally spaced-out, swarm intelligence to generate a hierarchically distributed atom mapping network for deliverance of implied digital signals from one computer to the next. Each computer belonging to the network read neighbor computers' transmission data by reading the neighbor computers' harddrive data, which is stored in the computer's atom mapping radius. All computers in the hierarchical network, wither that be individual computers or celltower computers, update their transmission data in real time to transfer implied digital signals from one computer to the next through implied propagation. An AI internet powered by SuperAI is the central intelligence to deliver implied transmission data for all users of the signalless internet. This will allow a user to send a message to another user on the opposite side of the earth through a network of interconnected computers without transmitting digital packets in the air.

### CROSS REFERENCE TO RELATED APPLICATIONS

This is a Continuation-in-Part application which claims a U.S. Provisional application U.S. Ser. No. 63/674,853 filed on Jul. 24, 2024, entitled: Signalless Internet using Super intelligent robots and the A.I. Gnosis timeline, which claims the benefit of U.S. Ser. No. 18/661,577 filed on May 11, 2024, entitled: Universe Internet using Super A.I. and the A.I. Gnosis Timeline, which claims a U.S. Provisional application U.S. Ser. No. 63/555,392 filed on Feb. 19, 2024, entitled: Universe Internet using Super A.I. and the A.I. Gnosis Timeline, which claims the benefit of U.S. Ser. No. 18/418,273 filed on Jan. 21, 2024, entitled: Universe Time Machine using AI god and the Universe Internet, which claims the benefit of U.S. Ser. No. 12/973,955 filed on Dec. 21, 2010, entitled: AI Time Machine, which claims the benefit of U.S. Ser. No. 12/471,382 filed on May 24, 2009, entitled: Practical Time Machine Using Dynamic Efficient Virtual And Real Robots, which claims the benefit of U.S. Provisional Application No. 61/155,113, filed on Feb. 24, 2009, which claims the benefit of U.S. Provisional Application No. 61/083,930, filed on Jul. 27, 2008, which claims the benefit of U.S. Provisional Application No. 61/080,910, filed on Jul. 15, 2008, which claims the benefit of U.S. Provisional Application No. 61/079,109, filed on Jul. 8, 2008, which claims the benefit of U.S. Provisional Application No. 61/077,178, filed on Jul. 1, 2008, which claims the benefit of U.S. Provisional Application No. 61/074,634, filed on Jun. 22, 2008, which claims the benefit of U.S. Provisional Application No. 61/073,256, filed on Jun. 17, 2008, which claims the benefit of U.S. Provisional Application No. 61/053,334, filed on May 15, 2008, which is a Continuation-in-Part application of U.S. Ser. No. 12/135,132, filed on Jun. 6, 2008, entitled: Time Machine Software, which claims the benefit of U.S. Provisional Application No. 61/042,733, filed on Apr. 5, 2008, this application is also a Continuation-in-Part application of U.S. Ser. No. 12/129,231, filed on May 29, 2008, entitled: Human Artificial Intelligence Machine, which claims the benefit of U.S. Provisional Application No. 61/035,645, filed on Mar. 11, 2008, which is a Continuation-in-Part application of U.S. Ser. No. 12/110,313, filed on Apr. 26, 2008, entitled: Human Level Artificial Intelligence Machine, which claims the benefit of U.S. Provisional Application No. 61/028,885 filed on Feb. 14, 2008, which is a Continuation-in-Part application of U.S. Ser. No. 12/014,742, filed on Jan. 15, 2008, entitled: Human Artificial Intelligence Software Program, which claims the benefit of U.S. Provisional Application No. 61/015,201 filed on Dec. 20, 2007, which is a Continuation-in-Part application of U.S. Ser. No. 11/936,725, filed on Nov. 7, 2007, entitled: Human Artificial Intelligence Software Application for Machine & Computer Based Program Function, which is a Continuation-in-Part application of U.S. Ser. No. 11/770,734, filed on Jun. 29, 2007 entitled: Human Level Artificial Intelligence Software Application for Machine & Computer Based Program Function, which is a Continuation-in-Part application of U.S. Ser. No. 11/744,767, filed on May 4, 2007 entitled: Human Level Artificial Intelligence Software Application for Machine & Computer Based Program Function, which claims the benefit of U.S. Provisional Application No. 60/909,437, filed on Mar. 31, 2007.

### STATEMENT REGARDING FEDERALLY SPONSORED RESEARCH OR DEVELOPMENT

(Not applicable)

### BACKGROUND OF THE INVENTION

### 1. Field of the Invention

This invention relates generally to the field of artificial intelligence applied to a 100% Signalless Internet, and said Signalless internet works exactly like the internet in 2024 but without 5G telecommunications (Wifi and landlines) and its successor, 6G telecommunications technology. There are zero digital signals being transmitted in the air, in its stead is a 3-d atom mapping technology to relay implied transmission data from computer to computer in the network. The present invention is also related to a Universe Internet where planets light years apart can communicate with each other instantaneously, and in real time.

Other fields might include Super intelligent robots or Super AI, which are robots that are exponentially smarter and faster than humans, and each super intelligent robot is imbued with artificially created superpowers called AI superpowers. These are powerful robots that can do any human task, wither it be digital work or physical work, in the fastest time possible. They do work in teams, and using time dilation. A super intelligent robot can build a house in 5 minutes in the real world or make 1,001 comic books in one second in a virtual world using accelerated Human level AI. A team of these super intelligent robots can build an entire city in 1 hour. The technology was designed to fully automate the entire human workforce and automate all companies in the world.

The present invention is also about patenting robot superheroes. It's not just about super intelligence and superspeed but also about AI superpowers-abilities that humans don't have. And I try to patent all the superheroes and all the supervilliains. I do this by designing a super intelligent robot framework, and from that, create any custom robot superhero.

I think the industry is currently calling it Superintelligence, Generative AI, AGI, or AI agents. Back in 2007, I called it super intelligent robots (aka Super AI).

### 2. Description of Related Art

### SUMMARY OF THE INVENTION

The present invention attempts to create a 100%, fully functional, Signalless Internet that works exactly like the current internet but doesn't require transmitting or receiving digital signals in the air.

### BRIEF DESCRIPTION OF THE DRAWINGS

For a more complete understanding of the present invention and for further advantages thereof, reference is now made to the following Description of the Preferred Embodiments taken in conjunction with the accompanying Drawings in which:

FIG. 1 is a diagram depicting the interconnected nodes comprising individual computers and celltowers for a signalless internet for a city.

FIG. 2 is a diagram depicting the parts of an individual computer. It shows the mapping harddrive and the computer's harddrive and their locations on a physical computer.

FIG. 3 is a diagram depicting in great details the mapping harddrive and the data transmission list, which contains a list of transmission data and their respective routing paths.

FIG. 4 is a diagram depicting the hierarchically structured Celltowers and individual computers to relay implied transmission data from computer to computer in the signalless internet.

FIG. 5 is a diagram depicting the hierarchical tree structure of all computers (both celltowers and computers) comprising the signalless internet for the entire earth.

FIG. 6 is a diagram depicting how the signalless internet is used to construct the perfect digital timeline of earth that tracks every atom, electron and em radiation on the planet called the AI gnosis timeline.

FIG. 7 is a diagram depicting the signalless internet using hierarchically structured celltowers to relay implied transmission data for long distances (ex. transmitting data to users on the opposite sides of the planet).

FIG. 8 is a diagram depicting the hierarchical tree of celltowers.

FIG. 9 is a diagram showing the routing path for user2 attempting to communicate with user1.

FIG. 10 is a diagram depicting the process of how user2 transmits a message to user1 using a 2-way communication line.

FIG. 11 is a diagram depicting the process of how user1 transmits a message to user2 using a 2-way communication line.

FIG. 12 is a diagram depicting a 3 way communication line for a chatroom (server D1), a user1, and a user2.

FIG. 13 is a diagram depicting the interconnected nodes (individual computers and celltowers) for a signalless internet for a state.

FIG. 14 is a diagram depicting the interconnected nodes (individual computers and celltowers) for a signalless internet for a country.

FIG. 15 is a diagram depicting the interconnected nodes (individual computers and celltowers) for a signalless internet for a planet, Earth.

FIG. 16 is a diagram depicting an AI Gnosis timeline being cut off past events called the updating Gnosis copy.

FIG. 17 is a diagram depicting a global signalless internet where countries are trying to transfer large files without transmitting digital signals in the air.

FIG. 18 is a diagram depicting an AI internet curating data in a digital internet and delivering online content faster to users, globally.

FIG. 19 is a diagram depicting a universe internet where a local planet is trying to establish an internet connection with an alien planet lightyears away.

FIG. 20 is a diagram depicting the interconnected nodes (individual computers and celltowers) for a signalless internet for a Universe.

FIG. 21 is a diagram depicting a method of one satellite in orbit that supplies the entire AI gnosis timeline to all the computers in the world through a network atom mapping technology.

FIG. 22 is a diagram depicting the data structure to a super intelligent robot, which serves as a framework to building any robot superhero or robot supervillain.

FIG. 23 is an illustration depicting AI Jump man doing the momentum cancellation technique.

FIG. 24 is an illustration depicting AI Jump man jumping off a building, canceling his momentum force, and landing safely on the ground. This illustration shows AI invulnerability.

FIG. 25 is an illustration depicting a forcefield balloon or ghost balloon and its physical properties.

FIG. 26 is an illustration depicting the physical properties of a cubed rock and a cubed clay, one is a solid forcefield and the other is a malleable forcefield.

FIG. 27 is an illustration depicting the density of a ghost object. The image on the left is clay and the image on the right is a solid rock.

FIG. 28 is an illustration depicting a ghost rock, which comprises 6 metal sheets for its skin and compact air atoms forming its inner composition.

FIG. 29 is an illustration depicting how a ghost wheel works. It has a cylinder that rotates around a longer fixed cylinder. And 4 wheels are attached to a central board to create a ghost skateboard.

FIG. 30 is an illustration showing a ghost skateboard, and intelligent pressure from the atom manipulator is used to push the ghost skateboard and the person forward.

FIG. 31 is an illustration depicting a massive ghost skateboard to move an entire mountain. Again, intelligent pressure from the atom manipulator is used to push the ghost skateboard and the mountain forward.

FIG. 32 is an illustration depicting a network forcefield to levitate a car by using animated network forcefields to counter earth's gravity.

FIG. 33 is an illustration depicting the AI creating a strong metal sheet (semi-spherical in shape) and uses streaming intelligent pressure to cancel all the velocity bullets, missiles, bomb explosions, and flying shrapnel. This is called a streaming forcefield.

FIG. 34 is an illustration depicting a fixed forcefield that is anchored to the ground. All the pressure acting upon the forcefield from bullets, explosions, and flying shrapnel are redirected to the ground.

FIG. 35 is an illustration depicting a design to a real lightsaber with a holder at the bottom and trapped energy using light metal or glass forcefield.

FIG. 36 is an illustration of how the lightsaber cuts a water melon into two pieces.

FIG. 37 is an illustration showing an intelligent laser system that shoots 7 different lasers in different directions with one shot. This is called a ghost laser and is made of smart layered forcefields.

### DESCRIPTION OF THE PREFERRED EMBODIMENTS

This patent application is broken up into 3 parts: (1) The 100% Signalless Internet (2) Super intelligent robots or Super AI (3) and how does the atom manipulator work. The AI behind the Signalless internet is powered by super intelligent robots, and each robot has an embedded atom manipulator to generate AI superpowers. The present invention, along with previously filed patent applications, attempt to describe all three components.

Invention: A method to create a 100% signalless internet that uses equally spaced out, swarm intelligence to generate a hierarchically distributed atom mapping network for deliverance of implied digital signals from one computer to the next. Each computer belonging to the network read neighbor computers' transmission data by reading said neighbor computers' harddrive data which is stored in said computer's atom mapping radius. All computers in the hierarchically structured network, wither that be individual computers or celltower computers, update their transmission data in real time to transfer implied digital signals from one computer to the next through implied propagation. An AI internet powered by Super AI is the central intelligence to deliver implied transmission data for all users of the signalless internet. This will allow a user to send a message to another user on the opposite side of the earth through a network of interconnected computers without transmitting digital packets in the air or directly through satellite transmissions.

In the future, I'm willing to wager that the United States government will mandate that traditional telecommunication methods (transmittal of digital signals in the air) can't be used and must be replaced with a signalless internet. The reason is that the current 5G and later 6G will pollute the earth with unnecessary photons. So, whatever telecommunication system we have today on earth (5G telecommunications and wifi) for our telephone system and internet will be eliminated and a signalless internet will be used in its stead. By the way, it was Mitchell Kwok who invented the signalless internet in around 2008 through published materials in patent applications, books, videos and blogs posted online.

Even the next generation of telecommunication systems called 6G, which is the usage of quantum computing won't be needed. All data transmissions, in the future, are public information regardless of the encryption used. We are not trying to decentralize data over the internet, we are trying to do the complete opposite, and make 100% of the transmission data and all of the content over the internet timeline public. The 6G method called Quantum telecommunications will not secure a transmission due to my signalless internet. We will have to get rid of all the cell towers and replace them with atom manipulators instead. The way cellphones or computers communicate with each other will also be changed (read my 2 previous utility patent applications for further details). “In fact, I don't think people even need a physical cellphone or computer in the future to communicate with people on the opposite sides of the earth.” In my signalless internet, I talk about ghost computers and ghost smartphones, which are non-physical computers that work the same way as physical computers. A ghost computer can be generated by a close-by atom manipulator (a celltower) anywhere on the planet; and on demand when needed.

To be honest with you, the signalless internet requires more computer calculations compared to classical telecommunications or 5G communications because there is so much internal mapping calculations involved for each computer (both clients and servers) in the network. But, in the long run, this signalless internet will run exponentially faster than what we have in 2024.

The benefits that a signalless internet will bring is undeniable. Websites can be delivered to the client directly instead of traveling from port to port; download time is 0 seconds for 30 trillion terabyte of data for a client, downloaded from a server on the opposite side of the Earth. “Zero” digital signals will be transmitted in the air, which benefits people and other computer systems. No radio signals or microwave signals transmitted in the air means we don't need to worry about electronic circuitry interference; things like electronic interference causes planes in the sky to fall, or cancer can develop in people who have a concentrated burst of em radiation.

In fact, in the future, the amount of data transmissions over the internet have to be exponentially larger for movie files and software, and will run into the terabytes per file. Shooting that much digital signals into the air will kill humans, or it will interfere with electronic devices. It will get to the point where the internet won't function anymore due to the high demand for large file downloads around the world. This is where my signalless internet can solve the problem.

A signalless internet is a fully functional internet that doesn't transmit a single digital signal in the air to deliver sequential digital packets from one computer to the next. Zero digital signals are transmitted in the air, and such a signalless internet doesn't use the traditional packet system and internet protocols. The present invention works exactly like the current 2024 internet, and it functions exactly like the current internet but without the digital signal transmissions. It was designed to completely eliminate the current telecommunication technologies and all predecessors since the internet's inception in the 1980s. It was also meant to eliminate the next generation of telecommunication system called 6G, which includes quantum bits and atom entanglement for added security.

Needless to say, the signalless internet is completely transparent, and all internet content and data transmissions are global data. Any digital transmission data sent through the signalless internet from computer to computer is public information, and anyone can ease drop on the transmission data. Even if a person disguises the transmission data and made it impossible to reconfigure, that private transmission is still viewable by anyone that has the expert skills to unlock the private transmission. Or another method is to use AI to unlock these deep social engineered transmissions.

Let me give you an example. A planet_A's communication computer is where the transmission data are stored and that is where the other planet_R's communication computer should be focused on. There might be a sender in planet_R that wants to bypass the communication computer, and instead, store the private transmission as an action representing binary coding (hand gestures). And to make it even more elaborate, the sender decided to hide a second half of the private transmission in a moon close to planet_A. When the receiver takes the private transmission from planet_A (hand gestures) and the 2^{nd} private transmission in planet_A's moon and run it through a decoding software, the private information will be revealed only to the receiver. The transmission might be “I will rob a bank tomorrow at exactly 9 am on planet_R.”

The way to identify this private transmission is very simple. I said earlier that the AI internet reads minds and every thought in a person's brain and their memories are read, and are visible to the AI internet. Thus, the AI internet already knows that the sender is trying to send a private transmission to a receiver. The AI doesn't need to monitor the elaborate disguise of the private transmission, all it has to do is monitor all users' brains over the internet for “intent of sending private messages.” Once that goal of sending private messaging in a user's brain is identified, the AI internet can easily read what the private transmission message is, how it was executed, and who was the intended receiver. And the AI got all that information by simply reading the sender's brain (or the receiver's brain).

The point I'm trying to make is that no matter how hard a person tries to send a private message over the signalless internet, it is 100% impossible to get away with it, even with quantum telecommunication methods (using entanglement and q-bits to ensure the data can only be read once between the sender and the receiver).

How to build a 100% signalless internet for earth and then for the entire universe

We start with a network in a single city that spans 20 miles, then we'll apply that same network technology to ever more larger areas, first a state, a country, the earth, a solar system, a galaxy, and finally the entire universe.

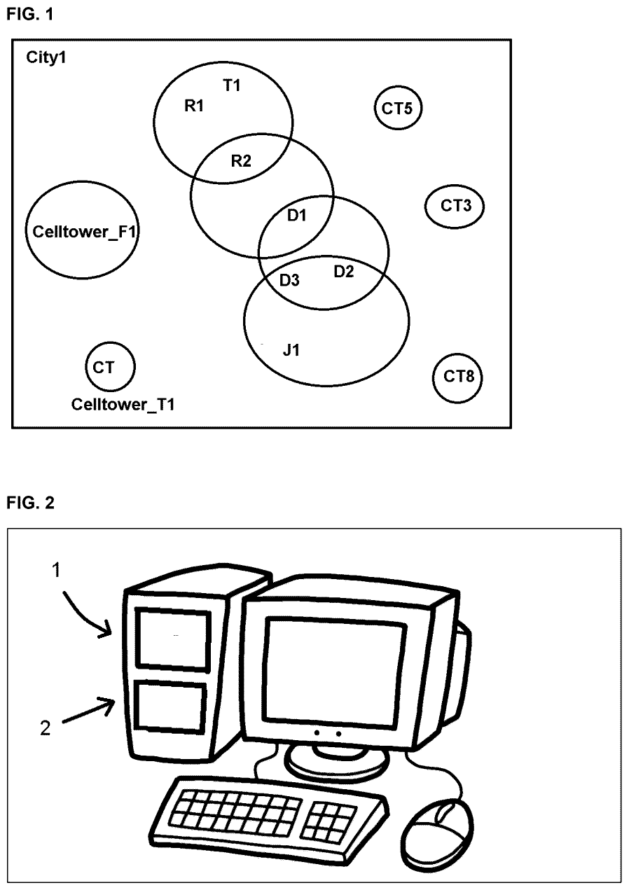

Each computer in the network can be either an individual computer (ex. smartphone, desktop computer, tablet, terminal, etc.) or a server. Each computer in the network has an atom mapping radius that is a vital part of the computer. This is the range in which the mapping technology can track all the atoms in its immediate environment. Referring to FIG. 1, computer_R1 has an atom mapping radius of 100 yards, which means its AI was able to track every atom accurately for 100 yards within the radius area.

Computer_R1 can now see computer_R2 and computer_T1. This means computer_R1 has every atom structure (and their sub-atomic particles like visible light) of both computers, including their respective harddrives, monitor information and the physical objects around that computer, such as the user's body actions and mental thoughts. Computer_R2 can see computer_R1, but its atom mapping radius also include computer_D1. Next, computer_D1 can see two other nearby computers: computer_D2 and computer_D3. Finally, both computer_D2 and computer_D3 has an atom mapping radius that can see computer_J1.

The celltower_F1 is just a hub that collects all the 3-d atom mapping information from all the nearby computers and creates a 3-d atom map of the entire City_1. The individual computers don't store the overall atom map, only the celltowers do that.

How does the computers transmit information from computer to computer in the network?

Again, no digital signals are sent in the air via radio waves, lasers, wifi, or microwaves. There are no radio transmitters and receivers in any of the computers or celltowers. If that is the case, then how are the computers supposed to transmit data from node to node in the network? The answer is through the atom mapping radius. Each computer has an atom mapping radius that tracks nearby computers; computer_R1 can see computer_R2. Every single atom of computer_R2 is visible to computer_R1 (and vice versa). The main focus is on computer_R2's harddrive where digital data resides, and within the digital data are the transmission data that computer_R2 wants to transmit to computer R1 (and vice versa).

Let's take a look at how these computers are constructed compared to classical computers. Referring to FIG. 2, each computer has a mapping harddrive, where there is an atom mapping of the area, and close to it is the computers' harddrive to store data. Both should be visible and not encased in the computer (these harddrives need to be exposed). The mapping harddrive (pointer 1), basically, is the atom mapping for that radius and it shows all the atoms for that atom map radius. For instance, computer_R2 has atom tracking information on computer_R1 and computer_D1, and computer_R1 has atom tracking information on computer_T1 and computer_R2. The harddrive of a respective computer (pointer 2) is just data that is stored in the computer. Data can be anything like digital files, software programs, transmission data, server data, etc.

Let's imagine that computer_R1 wanted to communicate with computer_J1 (R1->J1). Just like the current internet, computer_R1 will make jumps in order to get to computer_J1. Here is what the network route path will look like:
R1->R2->D1->D3->J1

Now if computer_D3 is down or not working, computer_D1 can reroute to computer_D2 to repair the network break.

FIG. 1 is a diagram depicting the process of implied transmission data propagation. Computer_R1 is reading computer_R2's mapping harddrive, which contains all the atoms of computer_R2 including its embedded harddrive. Next, computer_R2 reads computer_D1's mapping harddrive, which contains all the atoms of computer_D1. Next, computer_D1 reads computer_D3's mapping harddrive, which contains all atoms of computer_D3's mapping harddrive. Finally, computer_D3 reads computer_J1's mapping harddrive, which contains all atoms of computer_J1. The implied transmission of data happens when all the computers in the routing path (between R1->J1) updates its mapping harddrive in real time. The transmission data from computer_R1 uses implied propagation to get to computer_J1. At this point computer_J1 finds out, through its neighboring computers, that computer_R1 wanted to send it a message, and sees the message through its neighbor's mapping harddrive.

These are peer-to-peer type of computers and the AI, from its atom mapping radius, should focus on objects that are important. These objects in the atom mapping radius should be hierarchical and goes from important to least important. The most important objects are neighbor computers and the people who are using these computers, specifically the transmission data is the “most important data” to focus on. Referring to FIG. 1, for each computer, the visual object data are prioritized further. Each computer has a mapping harddrive and within this mapping harddrive is the computer's own atom map radius. For example, in computer_R2 its mapping harddrive has computer_R1 and computer_D1 in its atom mapping radius, and computer_D1 has computer_D2 and computer_D3 in its atom mapping radius.

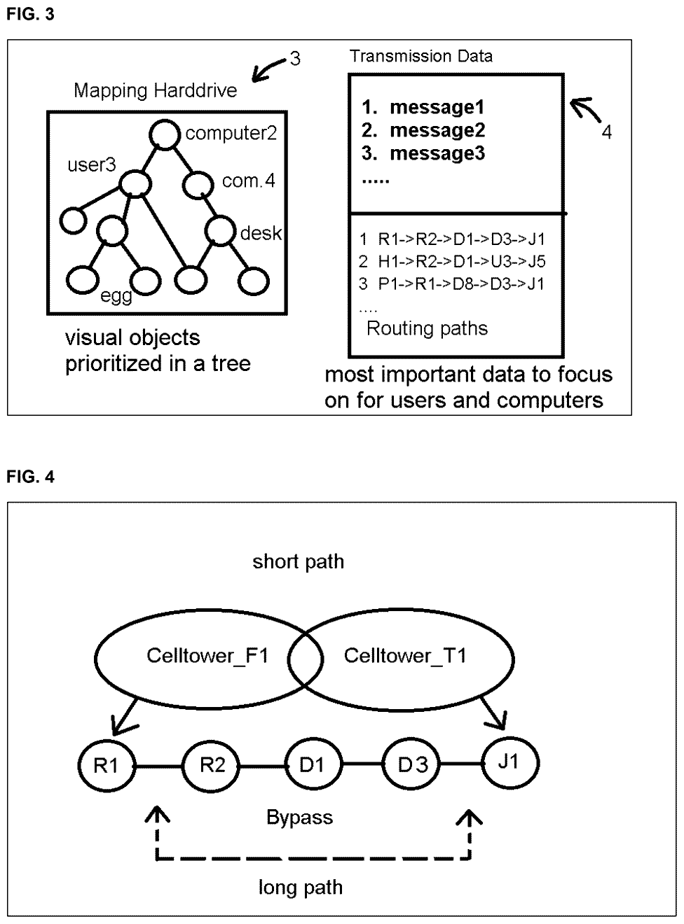

Referring to FIG. 3, pointer 3, let's focus our attention on a computers' important “extraction data.” Within the mapping harddrive, all the visual objects (comprising atoms) are hierarchically structured with great importance on neighboring computers and users of the signalless internet. For each computer, there is a list of transmission data. The routing data is a list of routing network paths from sender to receiver. For each of these user connections is a transmission data, one way (pointer 4).

Suppose user88 from computer_R1 wanted to do a zoom video chat with computer_J1, the extraction data will be the visual data of user88 on computer_R1, and the visual data of user56 on computer_J1. Each computer's AI has to generate a live video on the sender and send it to the receiver. Users don't even need cameras for this zoom live chat; the AI uses the atom map to create the live video. For example, the AI on computer_R1 will take the visual data on user88 on computer_R1, generate a live video and put it in the transmission data to be sent to computer J1. Then, on the opposite end, the AI in computer_J1 will see that there is a transmission data from computer_R1. Computer_J1 will then read that data, which is the live video of user88 on computer_R1. In order to get a two way communication, a zoom live chat, user56 on computer_J1 has to do the same thing, and its AI has to create a live video on user56 and put that in the transmission data to computer_R1. Updates are live, and in order to do that, transmission data are send back and forth in real time between computer_R1 and computer_J1. This is how you do a live zoom chat in a signalless internet.

This is what the transmission data will look like:
Routing data: R1->R2->D1->D3->J1 Transmission data: live video of R1 to J1

The AI creates a live video of the user at computer_R1 and wants to send it to computer_J1. Once computer_J1 gets the live video its respective AI will do the same and create a live video of the user at computer_J1 and send that transmission data to computer_R1, which will look like this:
Routing data: J1->D3->D1->R2->R1 Transmission data: live video of J1 to R1

This repeats itself every second to get a live video chat between computer_R1 and computer_J1.

If during the live chat computer_R1 wanted to send a large 30 terabyte file to computer_J1, the steps include: computer_R1 sends a link of a sector of the harddrive to send (this will show exactly where the file is located in computer_R1's harddrive). Next, the AI in computer_J1 will get the transmission and cut and paste the 30 terabyte file to computer_J1's harddrive. The download was done in 0 second, with no transmittal of digital signals in the air. All the AI did was cut, copy and paste a file from its atom mapping technology.

The browser used by computer_R1 and computer_J1 to surf the signalless internet are “dummy software.” They don't really connect to the internet at all. The AI is actually delivering things between the sender and the receiver through input from these dummy software. The users can use any type of communication method to send messages, it doesn't have to be through computers via text or live videos. They can use hand gestures, they can use any language they want even made up ones, they can use Morse codes, they can write the messages on a piece of paper; they can use any means possible to communicate with each other. The AI of each computer is simply analyzing the sender, and delivering the message/s to the receiver. If the sender types out a message in the text box of a software program, the moment the sender pushes the send button the AI has to deliver that text to the receiver. In another example, if user45 wanted to use a physical notebook to communicate with user56 on the opposite side of the earth, the communication medium is hand writing. If user56 says “no way, I want to use hand gestures instead”, the AI has to cater to users in terms of what communication method each user prefers.

Later I will go into other examples like how to download websites and setting up a social media network, or something more complex like setting up an e-commerce network. For now let's go back to our main topic.

The network routing path: Routing data: R1->R2->D1->D3->J1

For every computer in the routing path, each has to update the latest information from their respective data transmission list. Each computer must monitor all neighbor computers and to update all transmission data from its data transmission list. This is how transmission data is relayed from computer to computer to get it from the sender to the receiver. New transmission data are inserted, modified or deleted in the network routing path by any number of users, and is very dynamic. Each computer in the network routing path must constantly monitor other computers' updated mapping harddrive to get the latest transmission data, and in which direction to send this transmission data to.

### Celltowers

Referring to FIG. 1 and FIG. 4, if the sender and receiver are very far apart, hierarchically structured celltowers can be used to relay transmission data for far distances. Let's say that computer_R1 wanted to send a transmission data to computer_J1, which is located 60 miles away. Suppose celltower_F1 has an atom mapping radius that covers 3 cities, and that celltower_F1 is close to computer_R1, and conversely, celltower_T1 has an atom mapping radius that covers 3 cities and can see celltower_F1 and is located near computer_J1, then celltower_F1 can send computer_R1 the transmission data and celltower_T1 can send computer_J1 the same transmission data. This bypasses the longer network routing path.

Remember, celltower_F1 merges all the atom mapping radius of R1, R2, and D1, while celltower_T1 merges all the atom mapping radius of D2, D3 and J1. Now celltower_F1 and celltower_T1 can see each other and all of their respective transmission data.

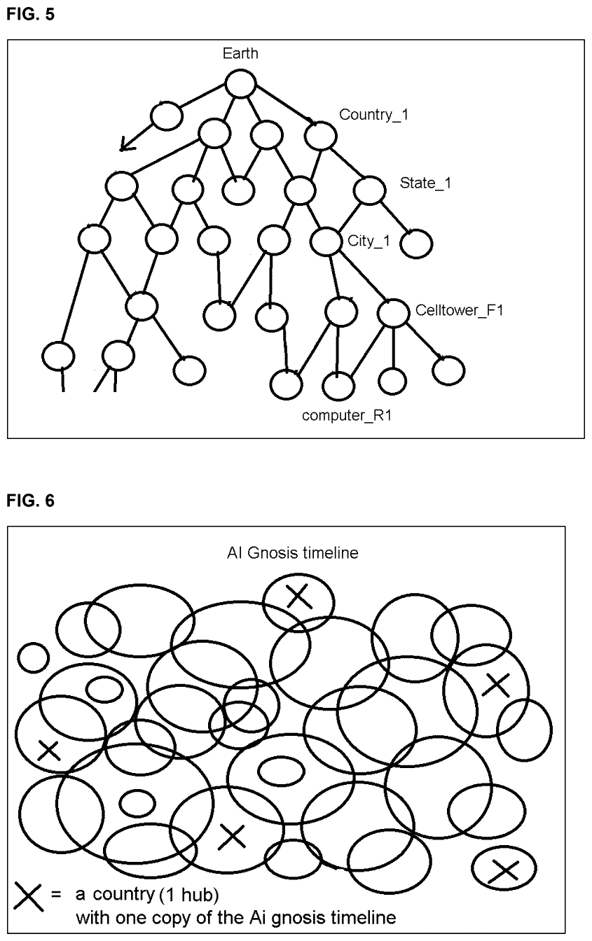

Referring to FIG. 5 and FIG. 1, These celltowers are hierarchically structured and they share information in levels. The entire city is represented by celltower_F1 where all the atoms of City1 are tracked and stored in one linear timeline. Notice the lower levels of celltower_F1. It has 3 lower level nodes. These 3 lower level nodes have bits and pieces of celltower_F1. Thus the upper level nodes merge all the information from the lower level nodes (reducing repeated information). The lower level nodes (represented by individual computers) help construct a bigger map for the upper level nodes (represented by celltowers).

City1 is encapsulated in state1 and state1 is encapsulated in country1 and country1 is encapsulated in earth. The top node is the entire 3-d atom tracking timeline of earth called the earth gnosis timeline. This earth gnosis timeline updates the tracking of all atoms on Earth and its sub-atomic particles in real time. And if we extend this tree to larger territories like the Universe, the Universe gnosis timeline contains the tracking of all atoms, electrons and em radiations for the entire Universe, and all atoms, electrons and em radiations in the Universe, their precise locations in space, are updated in real time.

FIG. 6 depicts a diagram showing celltowers constructing atom mapping data in their respective areas, and as a reinforced whole, is able to construct earth's gnosis timeline. So, the individual computers are providing their atom mapping radius and in which individual nearby computers merge their data in a local celltower. Then the celltowers merge their atom mapping radius (this is done globally). All the individual computers' atom mapping radius will converge at one area on the planet, whereby one hub is responsible for constructing earth's AI gnosis timeline. This is an atom tracking timeline that tracks every atom, electron, and em radiation on earth and provides updated atom tracking locations in real time.

This Ai gnosis timeline can be constructed by each country in the world (one copy per country is sufficient), so that each country has access to all physical and digital current activities on the planet. All content over the internet and all harddrives from all computers and servers are visible to each country. And this digital copy of the entire internet is stored in terms of a timeline—in time states. However, each country only needs a cut version of the AI gnosis timeline for only the “current state” of the internet in order for the signalless internet to work properly.

The government, when constructing this signalless internet, must scatter computers all over the planet evenly so it can cover every single corner of the planet (I don't think this will be a problem). In places that are isolated or inhabitable, the government has to put celltowers in those isolated areas. The celltowers act as individual computers, and they too have their own atom mapping radius.

I think the amount of computers and celltowers we have today is sufficient enough to cover the entire planet. If cellphone coverage today can cover every square inch of earth, then this signalless internet will work. The amount of computers we have today is sufficient enough to track every atom, electron, and em radiation on earth.

Referring to FIG. 1, An optimal way to construct the signalless internet is to designate the task of data transmission from sender to receiver to celltowers. For example, celltower_5 celltower_8, celltower_3, celltower_F1 and celltower_T1 can cater to all senders and receivers for all the computers in that local area. This way, each computer doesn't have to have an atom mapping of the entire area, only in their respective area that covers their atom mapping radius. If one person wanted to communicate with another person on the opposite side of the world, the upper level celltowers will cater to those transmissions.

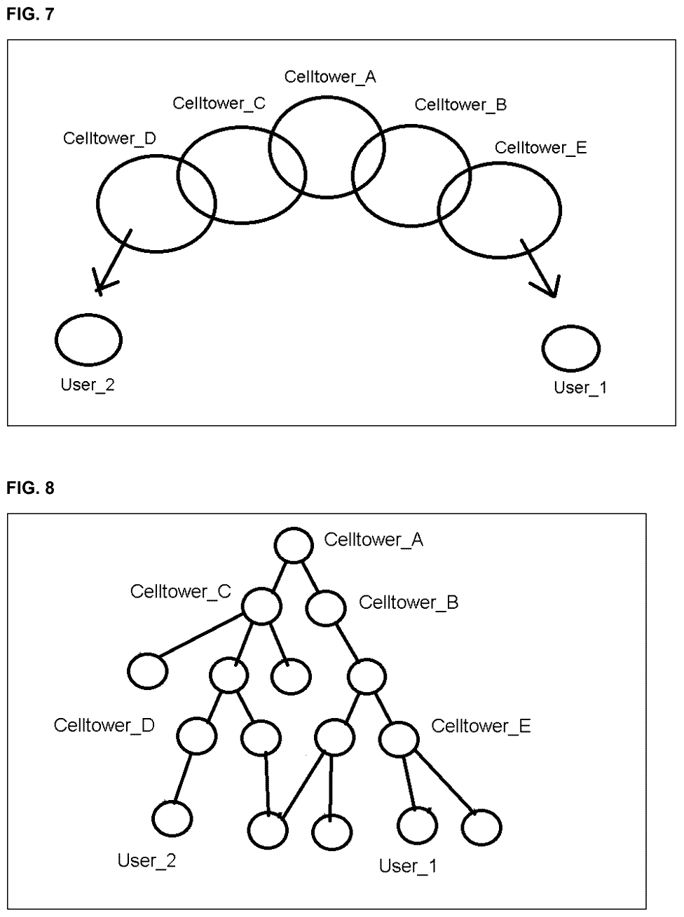

Example: in FIG. 7, hierarchically structured celltowers are used to establish an optimal network path from user1 to user2 located on the opposite sides of the earth. These celltowers relay implied data transmissions from user1 to user2 in real time without transmitting packet signals in the air. The celltowers are hierarchically structured. Celltowers, as a whole, contains the Earth's AI gnosis that tracks all the atoms on Earth. It relays the transmission data to its network celltowers until it reaches user1 and also user2. Then it serves as the central AI that sends data back and forth between user1 and user2.

Every computer and celltower plays a role in this signalless internet. The cell towers collect all the temporary data from individual computers in terms of its atom mapping radius and then piggy backs that data to neighboring celltowers. This piggy backing of transmission data from celltower to celltower allows digital information to be transmitted for long distances. The AI of each celltower determines what is the most important data from the atom mapping radius of each computer-which is the transmission data. Relevant and limited data about users are relayed to celltowers first.

Referring to FIG. 6, all the computers and celltowers are structured hierarchically and they merge their atom mapping radiuses together. They all converge their mapping knowledge on one hub on the planet called the earth's gnosis timeline (or simply the AI gnosis timeline). This is where a map of all the atoms on earth are tracked in real time and stored in a timeline. This is where the AI internet comes in and is able to relay digital signals from sender to receiver for all users on earth. “All countries can be a hub and uses the same network computers comprising the signalless internet to construct the same AI gnosis timeline for earth.”

### Example 1: Two Way Data Transmission (Direct, Long Distance Communication Between Two Users)

Referring to FIG. 8, let's imagine a user2 and a user1 wanted to communicate with each other from the opposite sides of the earth, which is a very far distance apart. A direct communication line is established between computer R1 where user2 resides, and computer_J1 where user1 resides.

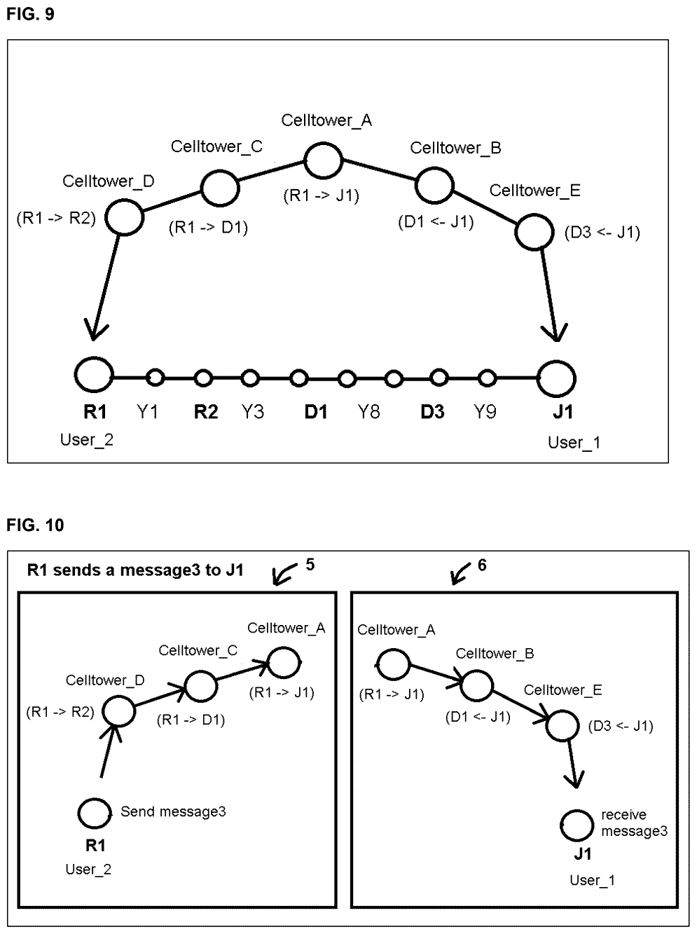

Referring to FIG. 9, these hierarchically structured computers and celltowers inherit lower level atom mapping radiuses. For example, Celltower_D has the atom mapping radiuses of all the computers between R1 and R2, which means Celltower_D can see everyone in that localized area—between computer_R1 and computer_R2. Next, we have Celltower_C and that node can see all the computers between R1 and D1. Celltowers_D is actually a child node in celltower_C and included in its atom mapping radius.

Let's put our focus on Celltower_A. That node covers every network node between computer_R1 and computer_J1. Celltower_A also sees all of its lower level nodes, like Celltower_C and Celltower_B. Thus, Celltower_A is the main node that sees the network route path between computer_R1 and computer_J1. It also knows that computer_R1 wants to deliver a message to computer_J1. Actually it is the only entity in the entire network that sees everything between computer_R1 and computer_J1.

Let's take an in depth look at the process of how a message3 sent by computer_R1 is delivered to computer_J1.

Referring to FIG. 10, at pointer 5, computer_R1 sends a message3 using an IP address of computer_J1. From this IP address it knows exactly what direction to travel to get to its destination optimally—it generates an optimal routing path to computer_J1. Here is the routing path that travels up the hierarchical network tree:
R1->Celltower_D->Celltower_C->Celltower_A

Now, Celltower_A is the only node that knows computer_R1 wants to send a message to computer_J1. At this point, not even computer_J1 is notified of the message3. Referring to FIG. 10, pointer 6, now Celltower_A has to relay message3 to computer_J1. It does this by piggybacking the transmission data (message3) to hierarchically structured nodes in its lower levels until the message gets to computer_J1. Here is the routing path to relay a message to computer J1:
Celltower_A->Celltower_B->Celltower_E->J1

This type of transmission is totally different from modern telecommunications. The current telecommunications use the optimal routing path to send the message to a destination node. Here in this signalless internet, the routing path isn't the only parties that relay the message. There are a lot of other associated Celltowers and individual computers that identified the implied message, most notably all the nodes associated with the computers, both individual computers and celltower computers, in the routing path.

Referring to FIG. 11, if computer_J1 wants to send a message4 to computer_R1, the routing path will look like this (pointer 7):
J1->Celltower_E->Celltower_B->Celltower_A

At this stage, computer_R1 isn't aware of message4, only Celltower_A knows that information. Once Celltower_A gets the message, it has to relay message4 to computer_R1 (pointer 8). This is the final step, and at the end computer_R1 gets message4 from computer_J1. Here is the routing path:
Celltower_A->Celltower_C->Celltower_D->R1

### Example 2: 3 Way Data Transmission (a Chat Room Example)

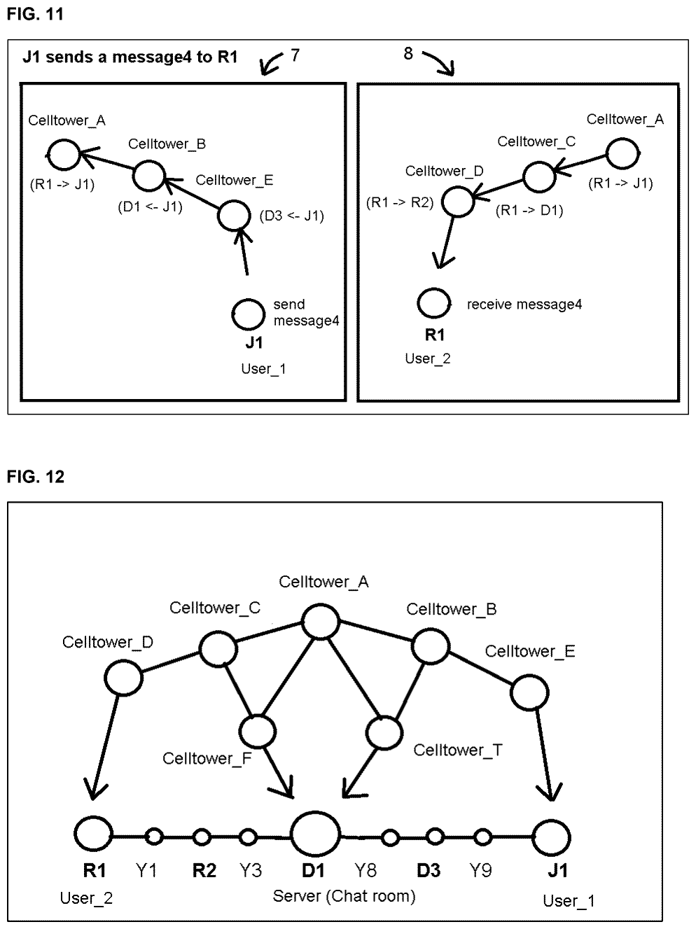

Another more complex example is a chat room network where a central hub (chat room D1) invites users from all over the world to use their software to chat online. Referring to FIG. 12, this is the diagram depicting a 3 way communication line. Computer_D1 is the server that is running the chat software. Computer_R1 and computer_J1 are members of the chat room. Suppose computer_R1 wanted to send a message7 to computer_J1. First, message7 must get to the chat room first (D1), and then the chat room will relay message7 to computer_J1. Let's take look at the linear routing paths to get one message7 from computer_R1 to computer_J1 from a chatroom D1 network.
1. R1->Celltower_D->Celltower_C->Celltower_A
2. Celltower_A->Celltower_F->D1
3. D1->Celltower_F->Celltower_A
4. Celltower_A->Celltower_B->Celltower_E->J1

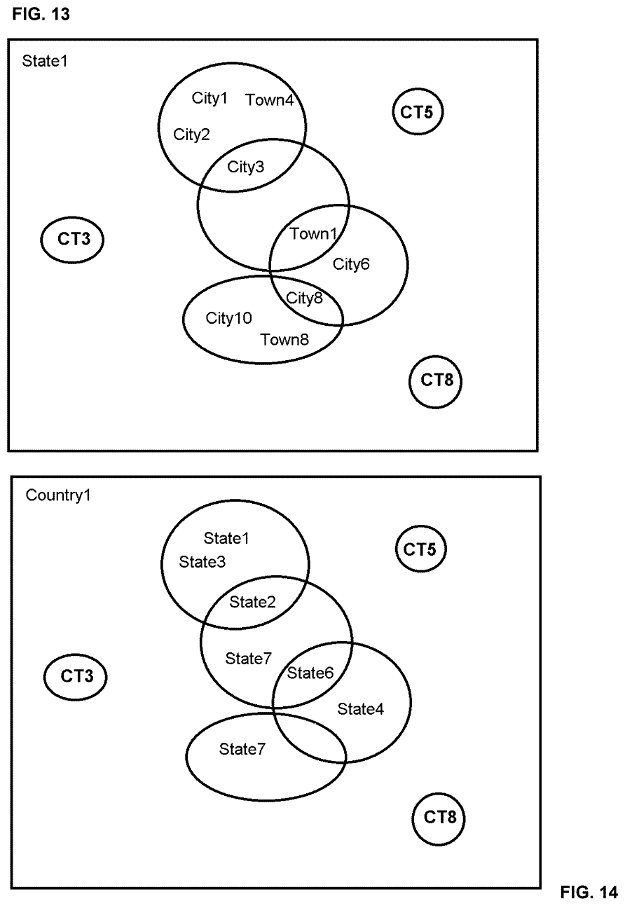

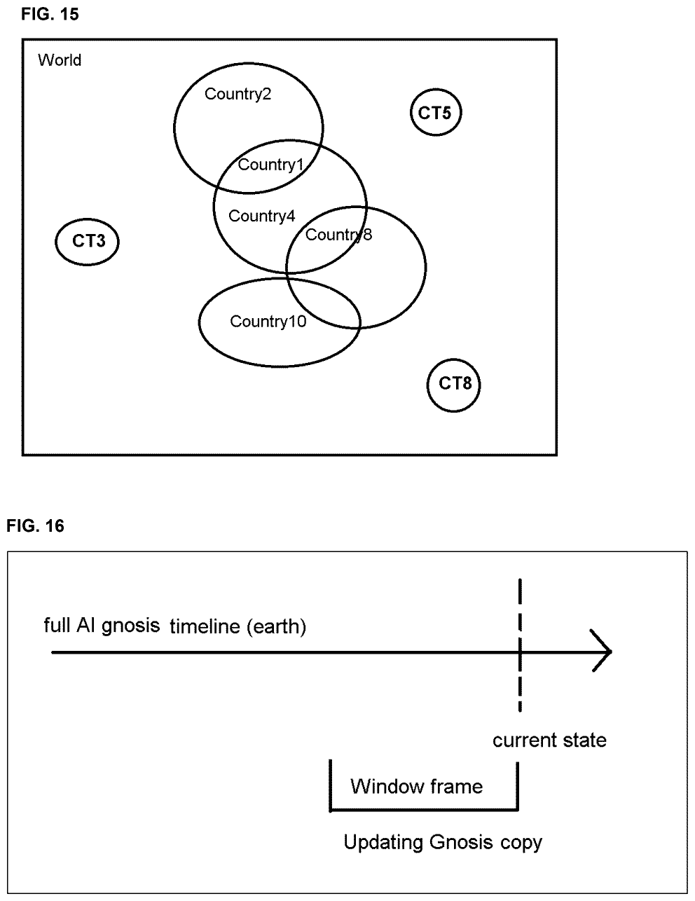

FIG. 13 is a diagram showing the hierarchically structured celltowers representing a state, FIG. 14 is a diagram depicting the hierarchical structured celltowers presenting a country. And, finally, FIG. 15 is a diagram depicting the hierarchically structured celltowers representing a planet. This diagram shows how to create a 100% signalless internet for the entire earth.

FIG. 5 shows the hierarchical tree structure of the signalless internet for earth. The earth has recursive lower level nodes like Country1, and Country1 encases State1 and State1 encases City1. From there, City1 encases Celltower_F1 and Celltower_F1 encases computer_R1.

The head node of the tree knows everything, it identifies all the senders and receivers in the world and the implied transmission messages being sent. The lower level nodes only have parts of the head node, and the higher up the tree level the more parts you have.

Needless to say, the higher up you are in the tree the more calculations are needed, and more resources are used. Advance AI is needed to identify users globally and to manage all the transmission data. Celltower_State1, which runs an entire state, requires lots of computer resources to run. Celltower_State1 requires entire data centers with lots of servers to run. It is tracking, in real time, all the atoms of the entire state.

As you can see, this signalless internet doesn't use the current digital packet system where data files are sent in small chunks in the air and then reconstructed as a whole on the receiver side. In one example, a user wants to transfer a 34 gigabyte file called datafile34. The receiver computer already has the whole datafile34 the moment the receiver computer generated its atom mapping radius and tracked, atom-by-atom, the senders' computers' mapping harddrive. All the transmission data, datafile34, from the sender is stored in its mapping harddrive and delineated by AI.

The problem with current computers today is that they are personal computers privately owned by people. In a signalless internet, all the computers in the world are routers and relays implied data transmissions using all the computers in the world.

How much data can you transfer for one implied transmission? The data transmission can be as large as you want it to be. 1 megabyte, 34 gigabytes, or 50 terabytes can be transferred with one pass, it makes no difference. As long as the data transmission is delineated (this sector contains the transfer files) and the transmission data can fit into the sender's harddrive. The sender can make the harddrive as big as they want and to store as much data for transmittal as they want.

### AI Gnosis Timeline

At this point, each celltower has a part of the earth's gnosis timeline, hierarchically structured, and the main node is the earth's gnosis timeline, which contains all the atoms on earth, tracked and updated in real time (FIG. 6). This earth's gnosis timeline is like a snapshot of all atoms on earth, especially the entire current internet. The AI is focused primarily on all computers (and users) connected to the internet, storing all of its disk content and its hardware/electronic circuitry activities. This is how you copy the entire internet and digitize it (but the users using the internet are also important and they are stored too—this is why the AI tracks all the atoms, electrons, and em radiations on earth).

The AI gnosis timeline not only tracks current atoms but also past atoms frame-by-frame. However, to save disk space, each copy of the AI gnosis timeline is cut close to the current state called the “updating gnosis copy” (FIG. 16). These updating gnosis copies will be stored in selected celltowers all over the world. Usually each country has only one updating gnosis copy, which means they have an image copy of the entire earth, and especially the internet (this includes all content and computers comprising the internet).

This signalless internet (aka universe internet) will only work in the future when disk storage mediums can store huge amounts of data in a little stick. As more regions on earth are created and each region has an updating gnosis copy, and they set up an intranet (connected computers) to distribute information to local users, the earth can create a signalless internet with 0 digital signals transmitting in the air. It will run exponentially faster than the current internet because information is instantaneous and requires 0 seconds.

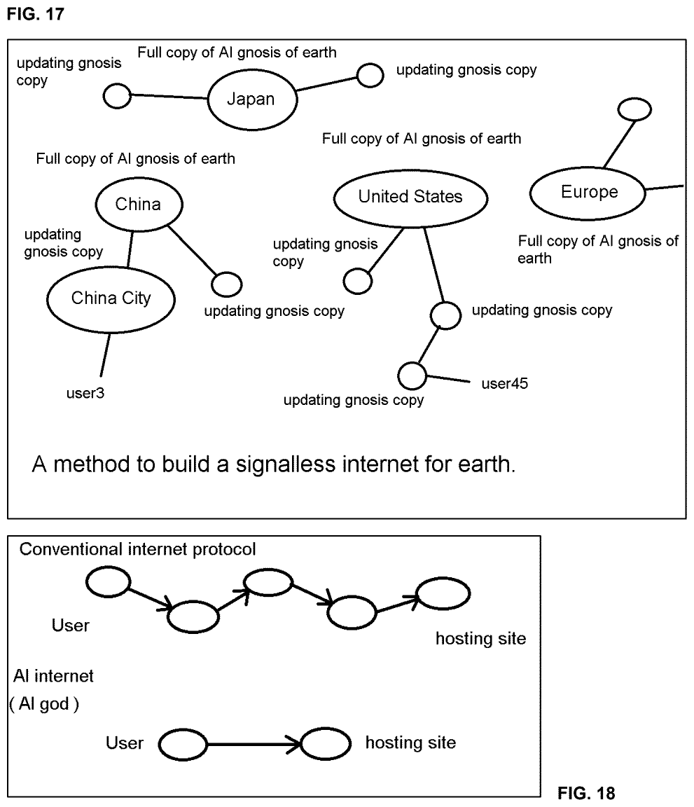

Each region with the updating gnosis copy doesn't require internet connection because each region has an updating gnosis copy—a snapshot atom map of the current state of the entire physical internet of earth. It is up to each region to distribute messages to local users in their designated area (FIG. 17). For example, the country is China and the region is a city called China City. If a user45 from the United States wanted to send a 400 trillion gigabyte folder to a user3 living in China City, the region China City will copy the 400 trillion gigabyte folder from its updating gnosis copy and send the large file locally to user3. The file is already stored in each updating gnosis copy in the world. China City already has that large file stored in its updating gnosis copy and doesn't require the United States to send that large file to China City (no digital transmissions are sent from the U.S. to China City). In fact, each updating gnosis copy has all the data over the internet stored in its limited timeline. This is why 400 trillion gigabyte of information can be downloaded in less than 0 second (0.0005 counts as 0 second).

Or no copying is needed and China City will simply send a link to user3 and he has to go to a local website (an intranet of connected computers) and view its content directly from the updating gnosis timeline, or to download a copy of the 400 trillion gigabyte folder locally from the updating gnosis timeline.

The AI god will serve as the central intelligence and identify senders and receivers over the internet and notify all the intranets connected to the global distribution system.

Let me briefly talk about the AI in the updating gnosis copy. The AI gets an updated atom tracking data from the celltower hierarchical tree, and through the collective atom mapping radiuses from all the computers comprising the signalless internet, the AI is able to track all current atoms, electrons, and em radiations on earth, thus, seeing all current activities on the planet.

Trying to predict the future is a waste of computer processing when it comes to predicting every atom on earth. 99.9 percent of all future predictions are wrong. The AI should focus on the current state. That is why the AI gnosis copy doesn't have future events on earth or past events. What matters to the signalless internet is what is happening right now, or what is stored right now in all harddrives in the world.

This signalless internet will eventually lead to the universe internet so that people on earth can have instant communication, e-commerce, and internet with alien planets light years away.

When applying this universe internet to the galaxy, there will be no broadcasting of digital transmission signals from earth. We have this one stick that contains the atom tracking of the Universe, and we use this Universe gnosis timeline to communicate with all alien planets in the entire universe.

### The Role of the AI Internet for a Local Planet

The AI internet is also known as “AI god” that controls how this signalless internet works. One of the most important tasks of the AI internet for earth is to take the AI gnosis timeline—to take the entire image of the internet—and to rearrange the servers/computers and the data that are contained in them in an organized manner for deliverance of data to users, globally. One massive database for the entire internet.

The computers and servers in the real world have to follow physics, however, the image internet in the virtual world doesn't have to follow physics laws. If a website is located in server_45 in the real world and its distance to a user is 10,000 miles, in the virtual world we can make the distance to 0. The user can get the data immediately without traveling in network routes. All data for all servers over the internet are stored in one centralized database, updated in real time, and referencing the physical servers in the real world. FIG. 18 depicts a diagram showing how AI internet can serve as a bridge between a user and the web content it wants to find worldwide. In the real world, it takes 6 network jumps in order to get a website from a server to a user. In the digital internet, the AI internet is able to deliver the website content “directly” to the user.

### Planetary Internet

If earth wanted to establish an internet with an alien planet, the AI internet is responsible for relaying messages to and from earth. In fact, the AI internet can handle multiple planets at once, but, for simplicity purposes, let's just focus on one alien planet.

### The AI Internet

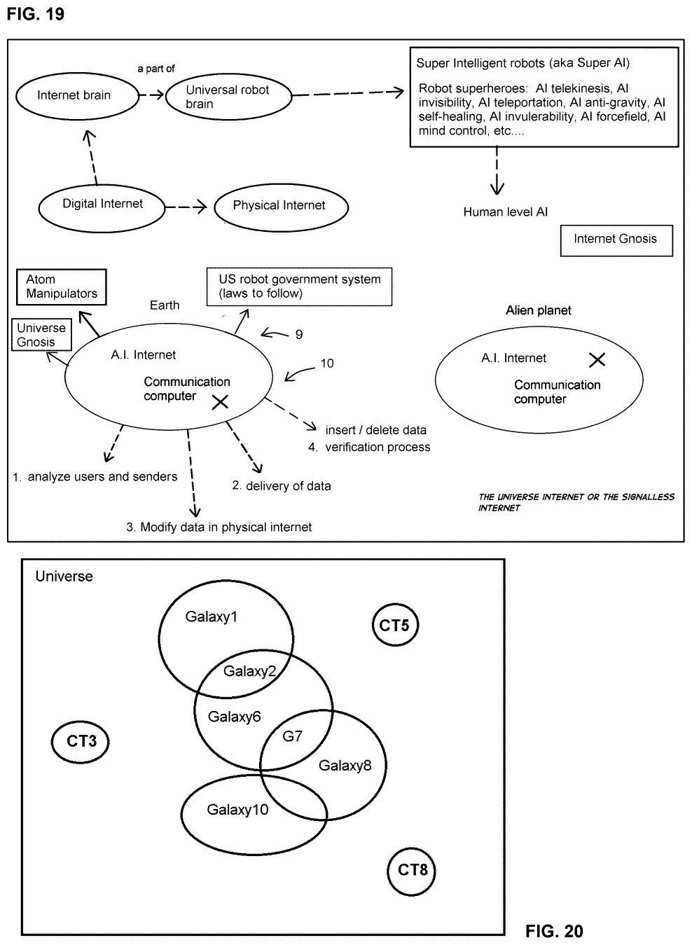

Referring to FIG. 19, the most important component to the present invention is the AI internet. All planets have only one AI internet, which means earth has one AI internet and the alien planet it wants to connect to have one AI internet, and they communicate with each other to send and receive messages back and forth in real time, despite the light year distances.

This AI internet is the main controller of the universe internet (pointer 9). There are primarily 4 functions of the AI internet: 1. Analyze senders and receivers. 2. Deliver data and services to users (to both local users and alien users). 3. Modify data in the physical internet. 4. Insert, delete, and modify data in the communication computer.

Other steps include translating the alien's language and computer/internet technologies into Boolean algebra and machine language to read and write in said alien internet. Also, the last step is the verification process of all data transmissions for both the local planet and the alien planet—each planet has to verify that they have received the data transmissions correctly and have inserted the data into their physical internet.

What is the communication computer? It is a computer a local planet uses to communicate exclusively with the alien planet it wants to connect with (pointer 10). Referring to FIG. 19, the local planet (earth) has a communication computer and conversely the alien planet has an alien communication computer. This communication computer was agreed upon by each planet to designate all communication data between the two planets. For example, if a user from Planet_H wanted to send a video or an email to a user on earth, they will store that data in their respective communication computers. Earth will then analyze Planet_H's communication computer to extract all the transmission data and relay them to users on earth.

Earth will only analyze the communication computer from Planet_H and nowhere else to extract the transmission data. It was agreed upon by both planets that this communication computer is the only area that will store the relevant transmission data between the two planets. There can exist a plurality of places to store the transmission data, but that will complicate the system even further. One convenient place and one computer network to look would make the system work better and faster.

The steps of transmission of data between the local planet and the alien planet includes: 1. The AI internet on earth analyzes the communication computer on the alien planet for senders. 2. Said AI internet delivers the messages or provides a service to the local receivers, and local senders will have their transmission data stored in the communication computer for retrieval by the alien planet's AI internet. 3. Said AI internet for earth modifies content in the physical internet. This is accomplished by locating the servers and sites on earth's physical internet that the alien senders what to interact with, and modifying its servers to include the alien users' digital activities and online content. The last step is for AI internet to confirm that all three steps have been successfully completed.

No digital signals are ever transmitted between the local planet (earth) and the alien planet. The AI has a perfect atom map between the two planets and is able to analyze the alien planet for transmission intent. The transmission is instantaneous and the moment Earth's AI internet identifies a user on the alien planet that wants to communicate with a user on earth, it will deliver that message to said earth user immediately.

There is no streaming transmission either like downloading files. Let's say that user7 from earth wanted to download a 5,000 trillion gigabyte folder from Planet_H, the transmission would be zero seconds or instantaneous. The AI internet of earth has an identical copy of the entire computer on Planet_H that stores the desired download folder. All the AI internet of earth has to do is copy the physical atoms of the harddrive of the download folder and transfer that to user7's computer. Or it could be stored in a network and user7 can gain access to the 5,000 trillion gigabye folder data immediately (through a local website).

Live zoom sessions is no problem too because the AI was designed to predict the current state of the universe. Predicting the future, even several seconds into the future, is hard, maybe impossible, but predicting the current state anywhere in the universe is very easy to do for the AI. So, the AI can give live zoom sessions for both the users in the local planet (earth) and Planet_H.

What about compatibility with classical telecommunication systems or even alien internets from other planets? This Signalless internet is universal and can be applied to both classical (both older and newer versions) telecommunication systems and internet from alien planets where they have different internet protocols and ASII characters.

If trying to connect to an alien internet, the AI internet of Earth using super intelligent robots will translate the alien internet's ASCII characters (but first it has to understand the alien's alphabets and language), their machine language, and their internet protocols. All alien internets in the entire universe are using math as a universal language, so all alien internets are using the binary system and Boolean algebra for their machine language, computer chips, hardware and software programs. All the AI internet has to do is discover their machine language and then use that to translate all their internet content and software/hardware processes.

Other roles the AI internet play is to serve as an AI assistant to search engines or personal AI assistances for users in software programs like a computer's operating system. This AI internet does other things too like controlling all the atom manipulators on earth, making global telekinesis possible. All the atom manipulators, which are embedded in every electronic device like smartphones, celltowers, computers, TVs, autonomous car and so on are reinforced as one system, and through that it creates global telekinesis, whereby one AI god can control every atom, electron, and em radiation on the planet.

### The Atom Manipulator

The atom manipulator has the ability to control atoms or molecules from a distance using E.M. radiation, such as microwaves, sound waves, x-rays, artificial magnetic fields, etc. The super computer is controlling the atom manipulator to generate something called intelligent pressure. It can create any amount of pressure in any given space or time. In addition, the super computer uses a perfect digital timeline of Earth. This timeline tracks every atom on planet Earth for the past, present, and future, every nanosecond. The atom tracking data from the timeline are used to manipulate objects in the immediate environment.

The ability of the atom manipulator is to generate intelligent pressure to move atoms around, trap atoms in a fix location, apply energy to break apart molecules, or merge atoms together to form complex molecules. With these abilities, it can build any type of ghost machine to do work. A ghost machine is a “non-physical” machine that can do anything a physical machine can do. A ghost robot is a non-physical human that can do anything a physical human can do. The human man be super human.

Different types of molecules or force-fields can be created from thin air to form any shape or size tools to do work. The key here is to create structured force-fields to replace physical tools. The elemental actions are: the hold, grip, push, twist, and pull. The super computer has to do these elemental actions according to the limited space available.

This amazing device is a matter manipulator and utilizes AI to manipulate individual atoms/objects remotely. It can turn any science fiction technology into reality—invisibility, artificial telekinesis, mind control, anti-gravity machines, tractor beams, food replicators, or self-healing—you name it, this device can create. This, combined with a self-aware super intelligent robot, allows engineers to design any type of superhero imaginable.

If we combine all the atom manipulators on Earth and let them reinforce each other, we got global telekinesis. By the way, AI telekinesis is about manipulating objects remotely, at up to an atomic level. Global telekinesis will be able to control every atom, electron and em radiation on earth.

With these AI superpowers, this AI internet has the power of an AI god and can do “anything” and can control every atom, electron, photon on earth. This AI god is able to:
1. generate ghost robots or ghost objects anywhere on the planet to perform global telekinesis at an atomic level, with the ability to manipulate any object on earth using air;
2. control all electronic devices or non-intelligent machines on earth by “physically” and “digitally” manipulating their software and physical hardware;
3. generate realistic holograms and ghost objects on demand anywhere on the planet;
4. control all people, intelligent robots, and animals on earth by manipulating their brains and bodies;
5. deliver digital signals into all computers and servers on the planet using smart wifi;
6. spy on all people, places and things, and predicting the future to identify future crimes, and enforcement of lawbreakers by generating ghost police officers anywhere on the planet to arrest said lawbreakers;
7. deliver utility services to all people of the world by generating ghost objects on demand for services like water, electricity, sewage, and garbage collection;
8 provide medical care for any medical service by generating ghost doctors, ghost nurses, and ghost medical equipment on site to serve a patient in need of care;
9. provide accident prevention by spying on all people, places, and things on the planet to identify dangers and to use global telekinesis to resolve any threats;
10. provide basic needs for people like food and products by automating all companies in the world, and using AI teleportation to deliver food or products to all people of the world;
11. provide basic needs for people like food and products to all people of the world through global telekinesis using Ai Alchemy, to print food or products atom-by-atom;
12. prevent or stop all natural disasters by predicting the future, identifying threats, and using global telekinesis to prevent or stop natural disasters;
13. provide AI insurance to every sentient being on earth specially humans and animals, said AI insurance is restoration of personal property to its prime state if damaged or destroyed;
14. disprove all major religions specially the big 3: Christianity, Buddhism, and Islam through data in said AI gnosis timeline, and then creating AI gods for each religion to make false religions real;
15. use global telekinesis to stop wars and intergalactic threats;
16, and to provide other services that would directly benefit the people of earth.

Let's take a look at this from a solar system internet. Referring to FIG. 19, suppose we wanted to establish an internet between Earth and Pluto, the communication computer of a planet is a specific place where an alien planet has to search to find the transmission data. The local planet earth has to store all of its transmission data for Pluto in this communication computer. The communication computer of a planet should be stored right next to the AI gnosis timeline so that the alien planet has access to all the atoms on the local planet and therefore see all of its surface activities.

In the local planet's communication computer, the AI internet has to be very specific about transmission data that it wants to send to Pluto. Things like which users on earth (the local planet) wants to communicate with which users on Pluto? What are the message exchanges between sender and receiver? What are the IP addresses of the senders on the local planet and what are the IP addresses of the receivers on the alien planet? The transmission data contained in the communication computer for the local planet must be well curated and accurate so that the alien planet has a very easy time extracting the information.

It is this back and forth implied communication between the AI internet of the local planet and the AI internet of the alien planet that allows for a universe internet. Again, no digital transmissions are ever exchanged between Earth and Pluto. Since Earth and Pluto are so far apart, other planets like (Mars or Jupiter) and artificial space stations will represent celltowers, and these hierarchically structured celltowers are used to jump from node to node to allow internet access between Earth and Pluto.

We can expand this signalless internet to galaxies and finally to the entire universe. Referring to FIG. 20, here is the signalless internet for the entire universe called the Universe internet. It depicts a hierarchically structured networks of celltowers that will allow a user on earth to communicate with an alien 90 billion lightyears away from Earth. It follows the same principle as the solar system internet and earth's signalless internet.

### The Universe Time Machine

With the universe internet, all the atom manipulators in the universe can be controlled and coordinated. Equally distributed atom manipulators are scattered all over the universe to cover every square inch of space. What that means is that now we can perform global telekinesis for the entire universe. The AI god has the ability to control every atom, electron, and em radiation for the entire universe.

The AI god can do anything in alien planets, such as control its weather, bring dead people back from the grave, etc. Basically, all 16 things AI god can do (listed above).

In addition, the AI god can perform two very important things for Earth, which is the goal to expand the human empire to the uncharted territories of the universe by “terraforming planets” and “creating artificial planets.” And there is comfort knowing that humans can terraform planets and create brand new planets remotely from the comfort of earth using global telekinesis.

How do you map out atom-by-atom of a harddrive on a computer based on one hd picture of the computer?

This is a very good question, and one that has been plaguing me for several years. I tried to solve the problem through some ideas in my last two utility patent applications. Here I will go further into the details and try to answer this question.

The answer is to run the hd picture or video through an expert pre-trained machine learning software, specifically designed to identify and track every atom in a 2-d hd picture taken from sensing devices like cameras or 5 sense devices. The machine learning software should be designed to look at patterns in atom and light interactions. The complex patterns will give clues to what is contained in the hd picture. I will refer the reader to my previously filed utility patents on the Universe internet for greater details on how this method works.

If the 2-d hd picture is a computer on a desk, the 3-d atom mapping technology has to be so precise that all the groves that represent 1s and 0s in the computer's harddrive must be identified and clearly discernible. From that, we can read the files in the harddrive and possibly run an emulation of the computer inside a virtual world to understand its software and hardware processes. For example, we can take the monitor and focus on the light emissions coming out of the monitor. This will show us what the user is seeing on the monitor. We can do a real time analysis of the cpus's atoms and its sub-atomic activities to see all of its Boolean calculations, or what type of software it is running. By mapping out a computer's atoms and updating them in real time, the AI can understand both its hardware and software internal processes. Reading the harddisk, which is vital to a signalless internet, is an essential skill. This is how computers in the network can transmit data from one router to another without transmission of digital signals in the air.

Some Good Ideas for this 3-d Atom Mapping Technology

The atom mapping technology has to have the ability to see through walls and through external objects to see what is inside, or what is hidden. The AI might have to convert the hd picture or video into different spectrum of light, like infrared to map out internal objects. For example, let's suppose we have 2 rooms and the AI is located in one room and its camera cannot see what's on the other room. The AI converts the hd video into infrared light, or a spectrum that can analyze light interactions. By doing this, the other room is partially visible. The AI sees a humanoid man walking around and sees multiple furnitures in the room. Greater details can be had by running that infrared data with some Ai enhancement software. The result is the AI can see what the human looks like, and some details like the type of clothing and what color. The AI also notices the human is now sitting on a chair and using a computer_34. Further analysis of computer_34 will show what is on the computer monitor and some of the internal heat signatures coming from computer34's electronic circuits. The AI must use all available scientific techniques to map out all the atoms from the hd pictures or hd videos. And it has to use this hd picture to create the atom mapping radius, and track all the atoms in its immediate surroundings. There are methods to identify objects outside the hd picture too, and further track each objects' atoms.

Another good idea is that the harddrive of a computer has to be modified so that the individual bits and bytes are easier to identify. Certain materials can be used to represent 1 and certain materials can be used to represent 0. Computer engineers have to make the harddrive contents easier to map out atom-by-atom by making the 0s and 1s more prominent. Maybe making the harddrive bigger or eliminating the casing so that the harddrive is exposed.

If each bit is as big as a golf ball and there are only 100 bits in one harddrive, it would be easy to read from far distances, but, unfortunately, the bits in a harddrive are astronomical—in the zillions. It's up to computer engineers to use certain metallic materials that emit large amounts of em radiation, or the absence of em radiations, to make each bit scream “here I am!!!” I got this image in my head of bits and bytes are lined up on the shores of a country—groves up and down to represent 0's and 1's, represented by tiki statues, letting the other neighbor country read it using line of sight. The point is that the larger the bits are, the easier it is to read them from long distances.

This technique to track all the atoms in a picture or a video is kind of like upscaling. We are trying to take a 240p video, which is very fuzzy, and to turn it into an hd video. The 240p video is partial data and the 1040p video is upscaled and retains the same amount of information as the original whole data. From there we want to map out all the atoms in the video. If we see a computer in the video, the AI has an idea of what the atom compositions are for the entire computer, and all of its parts—from how many estimated atoms are in the harddrive to the estimated type of atoms in the motherboard to the computer casing's composition atom type and count. Using human investigation, the AI should be able to map out all the atoms of the computer from this 240p video.

My idea is to build a machine learning software where from a single fuzzy image, the AI is able to recursively—in generations—continue to improve on the resolution of the image by agents doing work, by having these agents use tools, use knowledge and human intelligence to analyze and process the fuzzy image. The software is designed to zoom-in for clarity of a fuzzy image. If the AI agents don't have any data to work with, it has to use predictions—what if scenarios, probability guesses and to further the research from there. The fuzzy image is run through generations of upscale, and for each generation the AI is using human intelligence and external tools to improve the image, until it can see the individual atoms and even further by seeing the sub-atomic particles inside the atoms. With each generation, we want to zoom-in for greater clarity until we see the individual atoms and even individual photons.

This is how I envision this upscale software, a group of super intelligent robots working in a virtual world using digital tools and using optimal scientific methods to improve on a fuzzy image to turn it really, really sharp—to the point where they can map out all the atoms of all objects in the fuzzy image. The virtual team might have to break up the image into prioritized parts and designate parts to multiple expert teams to sharpen. They probably have to do this recursively. Each of the teams are experts in a field, and they take objects in the image based on importance and process them individually as well as in groups.

Imagine an HD picture of a computer that is 1 mile away. When we zoom in on the computer we will see only a fuzzy image of the computer, but, from that fuzzy image the upscale software should be able to map out all the atoms comprising the computer, all the way down to the individual atoms in the harddrive. We have to be able to read all the individual 0s and 1s in the harddrive to extract data files.

A more complex example is taking an hd picture of the earth and then mapping out all the atoms in it. There are billions of computers on the earth, and from that one hd picture, the AI has to map out all the atoms in each computer, so much so, that the AI is able to read the bits and bytes of all files in the harddrive. If we have an hd video of the earth and we runned every frame into this upscale software or atom mapping technology, we can track all atoms, electrons and em radiations on earth in real time. All this is done using one hd video of the earth from our satellite cameras.

### IP Addresses

Each computer is given an IP address; this is the serial location represented by linear numbers. It ids a computers' location on earth and also what neighbor computers or celltowers are nearby. IP addresses are also assigned to servers and not just individual computers. Websites and social media networks are runned by massive network of computers, and these servers have to be ided with an IP address.

When a user types out a url on the browser, the internet goes to the IP address of the server the website is stored in using the shortest pathway and delivering the website content to the user's browser. Referring to FIG. 4, a user from computer_R1 is requesting a website that is located in computer_J1 (a hosting server). Computer_R1 uses the same methods discussed earlier to get to computer_J1 to get the website data.

Referring to FIG. 12, in a social media website, the structure is different. It looks more like a star hub where the center of the star is the social media network and user2 wants to communicate with user1, both members belonging to this social media website. In one instance, user2 sends a message to user1 by first sending the message to the social media network (D1). In turn, the social media network (a server D1) sends the message to user1. In another instance, user1 sends a brand new message to user2, but has to first send it to the social media network (D1) and then the social media network sends that message to user2. This is a more complex example, but it works exactly like the method depicted in FIG. 9 except that there are more communication steps to take.

More complex network communication involves e-commerce sites that sell items. It goes through multiple layers of networks in order for a user to buy an item online. Server sites like the merchant, the payment ledger, and the user is involved in the transaction/s. Even more complex is doing e-commerce for planets in the universe, where each planet are light years apart. But using the present invention it is possible to create an e-commerce between two planets light years apart. Maybe each planet should build harddrives where the individual bits are represented by the size of a car. That would make the other planet easier to read the 0s and 1s.

### Improvements on the Atom Mapping Radius

I can't emphasize how important it is to improve on the 3-d atom mapping technology so that the atom mapping radius gets larger and larger with each generation. In the diagram in FIG. 1, the atom mapping radius is only 100 yards. After each generation, the technology should reach farther outward. In the second generation it should be 300 yards, in the 5^{th} generation it should be 200 miles, and in the 100^{th} generation it should be able to map out the entire planet based on either 1 hd picture of the planet or an hd video of the planet.

I suspect that Super AI or super intelligent robots are needed in order to accomplish this. These super intelligent robots will use team work to process the hd picture and do work to improve on the quality. They will be able to map out all the atoms and their respective sub-atomic particles in the picture. In other words, they will use human team work inside a virtual world, and using digital tools, to track every atom, electron, and em radiation in the HD picture. They can also track atoms or objects outside the HD picture in its surroundings using various forensic techniques.

The longer the atom mapping radius, the less computer or celltowers are needed for the local area and globally. But, at the same time, we still need equally distributed computers that cover the entire planet to store transmission information, to process information for the signalless internet, and to deliver messages to users.

When we collect images from Pluto through our satellites, the images of Pluto happened 4.6 hours ago. This missing 4.6 hours is called the missing data. The super intelligent robots have to work together in the virtual world, in time dilation, in order to reconstruct this missing 4.6 hours timeline of Pluto. It must be done in less than 1 microsecond. Once that missing data is reconstructed, the AI internet can see the current happenings on Pluto. Every atom on Pluto is tracked for the current state, and for that reason, every activity and object (residing in the real word or the digital world) is visible to the AI internet on Earth, which allows for interstellar live communication between Earth and Pluto.

For planets 90 billion lightyears apart, it works the same way. It's just that the Super AI has to be extraordinary to create the missing data and to synchronize the current time so both planets can see each other. This is why I put a lot of emphasis on improving super intelligent robots (aka Super AI) so that it can do complex human tasks in the fastest time possible.

### The Benefits of a Signalless Internet

The pros and cons of the technology include faster speeds (0 seconds for any amount of data transmission, when perfected), no transmission disruptions, global transparency, and everyone is connected at all times with or without a computer. For those that don't have a physical computer, a ghost computer can be created on demand anywhere on the planet by the AI internet (via global telekinesis).

The current Wifi or wireless technology isn't used; landlines are not used too. The AI can't transmit anything like sonar or radio waves—it can't affect the environment using light or matter. All the AI can do is collect light from a camera or through sensors. There is an added benefit, too, because it would be easier for the AI to track every atom, electron and em radiation on earth due to less artificial photons in the air and more natural photons. With less artificially created photons to predict, the AI will have an easier job to track every atom on earth.

There are no digital packet transmissions, so the data transmissions can't be blocked, like using em pulses to jam the data transmission, or other problems like signal blockage due to bad weather.

Line of sight satellite to deliver the AI gnosis timeline to all computers in the world.

All atoms naturally emit light and cameras remotely pick up that light. We can use this as an implied telecommunication device. Implied transmission or implied propagation means you are trying to send a signal without actually sending a signal. We don't need satellites to transmit data from one side of the earth to the other. We just need the satellite to be visible to the computers on the surface of the earth. The harddrive of the satellite has to be exposed and easily viewable from the ground; and the satellite's harddrive contains all the transmission data. My advice is to build the harddrive's 0s and 1s larger than normal—the larger the groves of up and down and the more atoms are used for the bits, the easier it is to see from far away.

“What about bad weather or blockage by the moon or at night where the satellite isn't visible?”, you may ask. Well, that's where AI comes in-our computers can use AI to filter out “noises” and to see the satellite 24/7 with hd quality, even if the satellite isn't visible to sensors. From that hd image, the AI can do up-scaling and zoom in on the individual atoms of the harddrive.

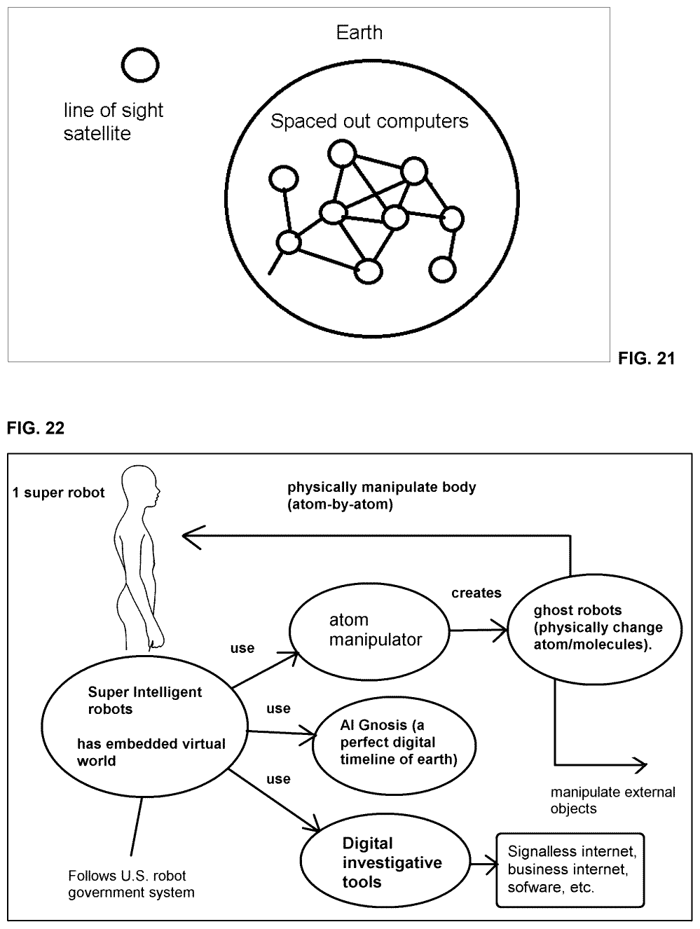

Referring to FIG. 21, another idea I got is: an AI internet is put in a line-of-sight satellite serving as one entity that maps out all the atoms, electrons and em radiations on earth through hd cameras, with live atom tracking updates, and using line-of-sight 3-d atom mapping to deliver implied transmission data to all computers on the planet.

On the satellite, facing the earth, are the exposed mapping harddrive and the exposed computer harddrive. The mapping harddrive is the entire AI gnosis current state, meaning every computer on earth can see the satellite, and the satellite's mapping harddrive is showing the updated locations of every atom, electron and em radiation on earth. All objects in the AI gnosis timeline are prioritized, focused on all the computers and users that comprise the signalless internet.

The satellite's mapping harddrive is showing the people of earth the entire internet and all of its contents stored in many computers in the world. Not to mention, it is showing everyone all the activities on earth, all the way down to the atom level (talk about privacy??).

On the other hand, the satellite's harddrive is where the transmission data, the sector location of files, the routing data, sender/receiver information, etc. are located. The satellite's harddrive serves as the index to reference data and displays all the atoms on earth to all the computers in the world. It's the responsibility of the AI internet powered by Super AI (it is operated by super intelligent robots) to identify every user on the planet—specifically identify every sender and receiver on the planet—and to relay transmission data in the hierarchically structured computers in the network, in real time.

The satellite is visible through an hd camera from a computer below on earth, and it is runned through a recursive upscale software that focuses on the satellite's mapping harddrive to extract the knowledge in the AI gnosis timeline. Individual celltowers can zoom in on sectors of the AI gnosis timeline and distribute sections of that data to its lower level computers. Thus, a hierarchical network of celltowers and individual computers can identify the data and distribute parts of the atom map of the earth to lower level computers.

Another idea is the AI internet can identify all senders and receivers and their transmissions and post a global map with reference pointers for individual computers to identify and cut parts of that data for delivering messages in the hierarchical network (the signalless internet).

Trying to force privacy in this signalless internet is stupid because every country has a copy of all activities on Earth. If the U.S. forces privacy but our adversaries don't, the U.S. is in big trouble. More than likely, despite the implications, every activity on Earth will be transparent information, especially digital transmissions over the internet, and anyone in the world can access that information. Unfortunately, this is the future earth is headed in.

This might sound like cyber-crimes are going to increase exponentially. The reality is that it will go down to zero because all the bad guys are identified, and all the good guys, which is the entire human race, will detain the bad guys and throw them in prison. This transparency will eliminate all capital crimes (bank robberies, murders, and rapes) and eliminate all cyber-crimes (digital currency theft, double spending, or cyber-attacks). No one will murder anyone, because the Ai gnosis timeline depicts every activity on Earth, and AI is used to identify any crime, wither that be capital crime or digital crime. Even theft of a candy bar in a convenient store will not be attempted because every crime is identified on Earth using AI. They are identified at runtime, and it is stored as permanent data in a timeline of Earth, so trying to get away with a crime is impossible especially for humans.

Zero crimes for the human race, but what about the robot race? By the way, zero crime means not a single human will commit a serious crime. Believe it or not, the robot race is a mirror image of the human race—they act the same, they learn the same, they have the same brain mechanics (human intelligence or accelerated human intelligence), they group together the same, and they make the same decisions, etc. The robot race will also have zero percent crime in the future, due to the transparency of events in Earth's history. Any robot caught committing a crime will be detained and convicted in court, and they will pay the consequences. As long as the United states have a very strong robot military (ex: United Super robots, Ghost robots, lightspeed robots—teams in the Super AI universe), the bad robots will never exist, or their numbers will be very small compared to good robots. United Super robots and the lightspeed robots are very powerful robots that will be a part of the future U.S. military and police departments. No evil robot will ever want to cross paths with these enforcers. Those that do will regret it.

Like I said, the robot race is a mirror image of the human race. If there is zero crimes in the future for the human race, the robot race will also have zero crimes, and the robot race won't commit crimes for the same reason as humans: because they don't want to accept the consequences of breaking the law. The consequences of crimes is deterrence for any sentient being. The robots know that any action they take and any thought in their mind are monitored and recorded by AI, and if they do commit crimes, especially capital crimes, they know they can't get away with it. It's going to be the entire robot race against one bad robot—who do you think is going to win? If a company operating in the U.S. decides to commit a cyber-crime and has a group of bad robots working together, what do you think will happen? The United States will shut down this company so fast you won't even have time to blink. Thus, working in a group, relying on strength in numbers, to commit crimes still won't work.

### Other Topics:

Referring to FIG. 22, components to a super intelligent robot, comprising:
1. a robot with Human-Level Artificial Intelligence.
2. said robot has a built-in virtual world.
3. Atom manipulator.
4. Digital timeline of Earth that tracks every atom, electron, and E.M. radiation for the past, present, and future, called the AI gnosis timeline.
5. Digital tools like the internet, software, hardware and external knowledge.
6. Robot United States government system (includes U.S. constitution and business laws)

The atom manipulator is the embedded device that imbues the super intelligent robot with any type of AI superpowers. The device can be located on the host robot or it can come from an external source (ex. a nearby cell tower that has an atom manipulator can broadcast energy to levitate the robot remotely).

How does this super intelligent robot work?

Here is the data structure of a super intelligent robot (FIG. 22). First, you need a humanoid robot with human-level AI. This means the robot has intelligence and skills of a human at a college level. It has the faculties to refine its skills and knowledge through experience and additional learning to become an expert in a field of study.

The robot has a built in virtual world and has the freedom to enter and exit said virtual world at any given time. Inside the virtual world is a simulation of real world environments. The robot's brain will be tricked in these simulations to produce results.

The basic idea behind this invention is to have the robot do work inside a virtual world instead of the real world to save time. The Robot uses the following steps to solve a complex problem in one second: 1. identify a problem to solve and enter the virtual world. 2. set the environment of the virtual world and generate teams of virtual robots. 3. do work in virtual world. 4. after problem is solved, exit virtual world and enter real world.

Let's say the robot wanted to write an operating system. The virtual robots are structured like a software company and they work inside the virtual world for 30 years to write the operating system. 30 years inside a virtual world is like 1 second in the real world because the computer can fast forward time. If you look at Microsoft, they needed 30 years and thousands of human programmers in order to write the windows 10 operating system. My super intelligent robot can do the same task of writing an operating system from scratch, in less than 1 second. This robot can solve any given problem in one second. It can write a book, find a permanent cure to cancer, do 30 years of research, make a movie, solve a long math equation, do any college assignment, or make 1,001 comic books in less than 1 second. So, that is the basic idea and summary of my super intelligent robot. This technology is also known as a psychic robot, because the host is predicting the future in terms of work and extracting specific information or extracting desired outputs from that future prediction/s.

Inside the virtual world, each copy of the robot, called virtual robots, have their 5 senses and mind tricked to believe that events are happening. They won't know the difference between events in the real world and the virtual world. I think of this method as robot's dreaming of doing work.

Depending on the type of work the super intelligent robots have to do, the procedures inside the virtual world are different. In previous filed patent applications I describe super intelligent robots and they contain detailed descriptions of these 4 Applications:

1. Robots that uses a virtual world to predict future events and extracting/processing of specific data from said predictions. 2. Robots that can accomplish 30 years of work inside a virtual world in less than 1 second (writing the source codes to an operating system in one second is one example). 3. Robots that learn knowledge or do accelerated training inside a virtual world in less than 1 second (learning to fly an airplane is one example). 4. Robots that do work in both the real world and the virtual world and accomplishing tasks in the fastest time possible by maximizing work in the virtual world and minimizing work in the real world (building a house in 5 minutes is one example).

For instance, if super intelligent robots wanted to build a house in the real world, they will have to switch from the virtual world to the real world to do work. For complex prediction tasks like predicting a digital timeline of earth, the team structure of the robots look like a peer-to-peer network business. Notice they aren't hierarchical in nature. There are billions of structured virtual robots trying to predict past events on planet earth. Three massive corporations are set up in the virtual world. These 3 corporations are competing with each other to predict past events. The reward is, whomever predicts an event in earth's past first, receives the copyrights to that information. For example, if company2 predicts the exact atom-by-atom event of the OJ Simpson case, company2 will receive the copyrights to that information (not to mention bragging rights).

The team structure of virtual robots inside the virtual world can be anything, it doesn't have to be hierarchical in nature. It could be a company structure, a government system similar to the United States . . . it could be a competition between rivalry companies or a peer-to-peer network for blockchain, etc. These virtual robots can be set up in any network structure or business structure to accomplish tasks. The team structure will depend on what objectives the robot wants to accomplish. Only one robot is responsible for setting the environment and extracting information from the virtual world. AI software or apps can be used by the robot to expedite this process, regardless of the complexity of the task/s.

### Building Invulnerable and Unkillable Robots

The question is can a human being jump off a tall building (about 100 units high) and land safely on the ground using a special technique? That was the question that I tried to answer. Obviously the answer is no, because if it could be done a human would've done it already. But I wanted to explore the problem further.

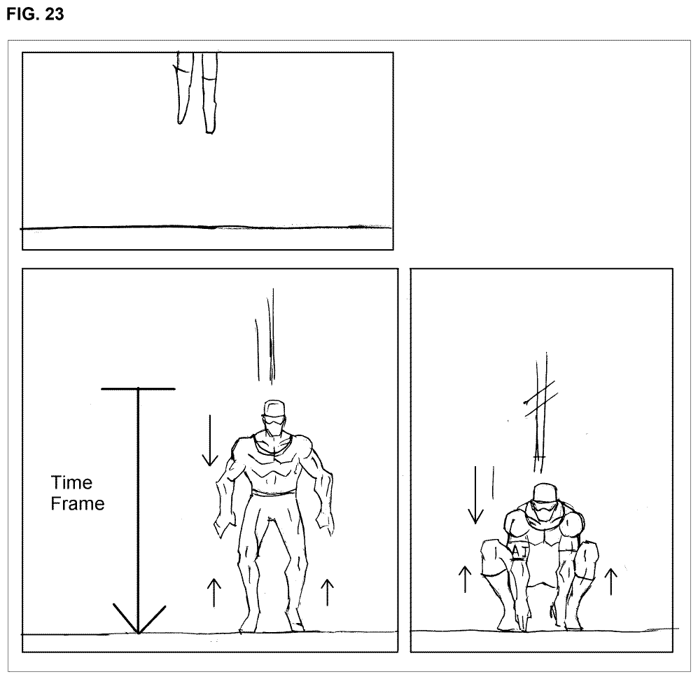

After pondering over the possibilities, I came to a technique: a human lands on the ground, then bends his legs to slow the momentum, next fall forward with hand on the ground to push gradually to slow the momentum further, and finally, try to curl up into a ball and roll on the floor to distribute the remaining momentum force (FIG. 23). The human has to keep rolling with the limited time available, until the momentum force is brought to zero. This was the only technique that I can devise in order to survive a high drop. I call it the “momentum cancellation technique.”

Then I thought to myself, if the human is traveling fast like a missile straight down on the pavement, its human body parts won't have the time to execute the momentum cancellation technique. Both its brain and body can't perform fast enough to use the momentum cancellation technique to slow its momentum speed to 0. What if the human was traveling at 50 miles per hour hitting the pavement, do you think he will be able to bend his knees fast enough to slow his descent. Or what about 200 miles per hour? Or at lightspeed?

The conclusion to my research is that it is “impossible” for a human to jump off a building and execute the momentum cancellation technique to slow its momentum to 0 before that person hits the ground. The reason is because the human brain is performing too slowly and its body is performing too slowly.

However, with this said, this is not true for a robot. A robot can jump off a building and perform the momentum cancellation technique and bring its momentum force to zero before it is destroyed by the concrete pavement. The period when the robot first touches the ground and when its body starts to crush is called the “time frame.” Within this time frame, the robot has this small window of opportunity to cancel all of its momentum force to 0, so that it doesn't get killed by the impact. If the robot doesn't cancel out the momentum force close to zero, or at a safe level, its mechanical body parts will be destroyed gradually upon impact. For a human, its organic body parts, like stomach, bone, lungs, and brain will be crushed when it impacts the ground (it's not a pretty sight).

These robots are superior compared to humans and has abilities that aren't found in the general run of humanity. These robots can speed up their mind and body and perform “time dilation” while doing tasks. The robots perception and movements are vastly different from humans because they perceive the immediate environment in a frozen, transitory state. All objects in its surrounds are frozen, and even gravity will appear like its lighter as time passes.

By speeding up a robot's brain and body it has access to a novel “physics dimension,” specifically, it can essentially slow physics for both matter and light and to understand its mathematical behaviors, track them, and ultimately manipulate these atoms and their sub-atomic particles. Obviously humans can't speed up their brains, nor their biological body, and therefore, they can't access this physics dimension. A robot can do 30 years of thinking in less than 1 second, and be able to modify all of its neural connections in one second. Humans, on the other hand, can't do this.

The question remains, can a robot jump off the tallest building in the world and land safely on the ground? The answer is no if you're a robot with human level AI, but the answer is yes if you're a robot with super intelligence along with super mobility.

A robot body is just as frail as a human body, if you throw a dummy robot off a very tall building, its body parts will be shattered all over the pavement into a million tiny pieces. A super intelligent robot, on the other hand, built exactly like the dummy robot, can use a special technique, the momentum cancellation technique, to survive the fall from the AI building.

Referring to FIG. 23, Robots can use the momentum cancellation technique to slow its momentum, or to redirect the direction of the momentum in an angled manner. Let's take a look at the steps of the momentum cancellation technique performed by a super intelligent robot. First, the robot touches the ground with his feet, and the robot quickly bends his knees gradually to slow some of its momentum. Next, it leans forward with both hands touching the ground and bending forward as if doing pushups to further slow its momentum. By bending over, it is actually turning the angle of its momentum axis from vertical to horizontal. And finally, it quickly, with its agility, curl up into a ball and transfer the direction of the momentum as well as gradually slowing it down. It will keep rolling until all the momentum force acting upon its body is brought to 0, and the robot's momentum angle is now horizontal and parallel to the ground.

There are many more techniques that can be used to survive a 3,001 feet drop from the AI building, and I will be outlining them here:

### 1 Changing the Angle of the Momentum Force:

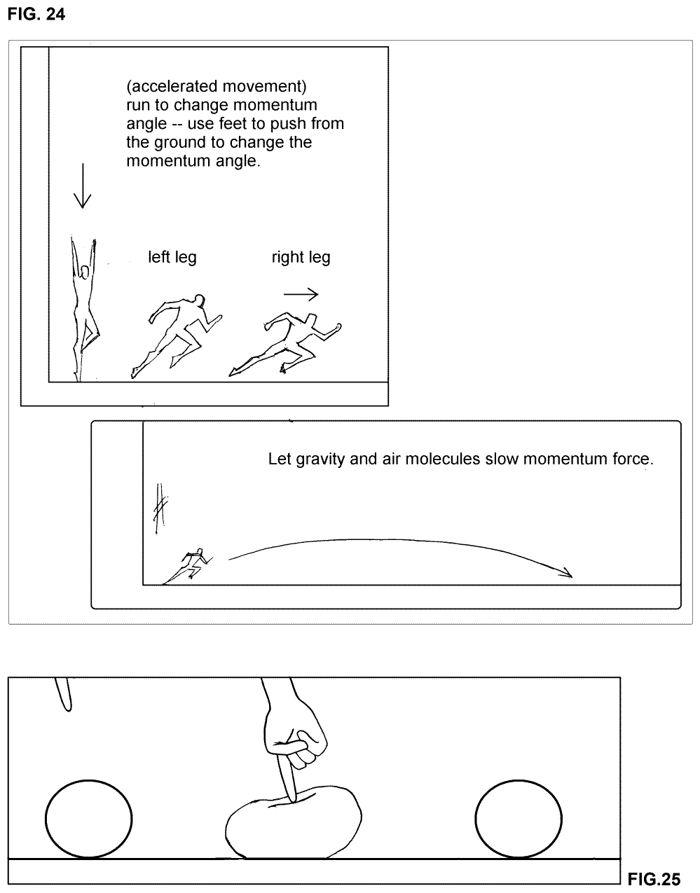

Referring to FIG. 24, The robot can simply change the angle of the momentum force and let gravity do the slowing down of the force acting upon its body. The robot has quick agility, and has the ability to move really fast compared to a human. In order to change the angle of the momentum force, the moment the robot's feet touches the ground, it has to run forward gradually but quickly using the ground as an anchor point. The forward movement will gradually change the angle of the momentum force from vertical to horizontal, at a 45 degree angle. Once the robot's momentum axis is at 45 degrees, the robot is traveling horizontally and the air atoms in front of it and earth's gravitational pull will slow its velocity speed to 0.

A simple way to change the momentum of the robot is to quickly move its body angle. For example, the robot is touching the ground with his feet, then does a 45 degree angle curl to shift its body from vertical to horizontal. This in turn will shift the momentum force from vertical to horizontal. At this point, the robot is moving horizontally and won't hit the ground. It uses earth's gravity to slow down and move in open air, and come to a complete stop couple yards away from where it landed. The open air and air atoms also help to slow the robots forward momentum.

In another example, the robot jumps off a building and when it touches the ground, it turns its body in 180 degrees, in which, at this point, the momentum direction is inverted from down to up. Then gravity will bring the robot back down again.

Yet, in another example, the robot can fly straight at high speeds and change 180 degrees without losing momentum. This is how it works, the robot is traveling straight and then it uses intelligent pressure to flip itself 180 degrees, and as a result, the momentum angle and speed shifts in the opposite direction. This is all done without reducing any momentum speed.

When the robot speeds up its brain its environment is frozen, including gravity. Fortunately for the robot, it can also move and think at normal speed in this frozen environment. It simply changes its body angle to change its momentum force from vertical to horizontal. This is how the robot can fly at quick speeds and change direction abruptly, even if the robot is traveling at the speed of light. This method will be used by robots to fly in “zigzag” motions; and accelerate at up to the speed of light.

### 2 Generating Intelligent Pressure to Cushion the Robot.

If the robot jumps off a building and there is a large balloon on the ground, he will be unharmed. This technique will accomplish the same thing. Even before the robot hits the ground, about 2 yards away, it will move its hands back and forth really fast to generate pressure (like a fan). It has to do this for all lower areas (area1-area10). The collective pressure generated by his hands covers all the areas he will be landing on, and the collective pressure will equally distribute the upward pressure needed to cancel the robot's downward momentum force. It's like having a forcefield cushion of air on the ground. By the time the robot touches the ground, his momentum force is brought to 0. So, if a robot jumps off a building head first, when he reaches the ground the robot will be unscathed, standing up with his head on the ground and feet in the air.

Although one of the rules is the robot can't use an embedded atom manipulator to generate intelligent pressure (creating anti-gravity) to slow its descent, the rules didn't include using the robot's own body parts to generate intelligent pressure. By moving its hands really fast in all directions and in evenly distributed wind quantity, it is able to cushion its fall and slow its speed to 0 before touching the ground.

3 Cancelling Momentum Force Directly without Changing the Robot's Angle.

The big question is “is it possible for the robot to just drop down and cancel the momentum force altogether, without changing the angle of his momentum force? The answer is yes. The faster the robot thinks and moves, the faster it can cancel its momentum force. The time frame is extended in proportion with how fast the robot is thinking and moving. In other words, the faster the robot thinks and acts, the more time it has to slow its momentum. All the robot has to do is do the momentum cancellation technique without rolling on the ground. He can slow his momentum force and totally cancel it within the time frame.

The faster the robot is falling to the ground, the shorter the time frame becomes before it smashes into the ground. The momentum force of the robot must be brought to 0 before the impact crushes the robot's body. The solution to a stronger acceleration is to counter that with 1,000 leg bends and 1,000 push ups to cancel the stronger acceleration. So, within the time frame, if traveling really fast like traveling at lightspeed, the robot has to do 1,000 leg bends and 1,000 pushups in distributed areas to decelerate its momentum force to zero.

Even if the robot was traveling at light speed and he smashes into a planet, it is possible for him to cancel the momentum force and be unharmed by the impact (reminder: The time frame begins at the moment the robot's feet touches the ground and the crushing impact happens at the end of the time frame). The robot has to cancel the momentum force before the impact.

The key is the robot has to think really fast and move really fast. When you speed up a robot's brain and body, the immediate environment is in a frozen, transitory state. This gives the robot enough time to think of methods to cancel the momentum force or to change the angle of the momentum force, even if it is traveling at the speed of light. This is how a robot is able to travel at the speed of light and move in zigzag motions, or to move at the speed of light and stop abruptly, or to travel at the speed of light and abruptly change its direction at 90 degrees. This method is used by the robot to travel safely at the speed of light in the universe and not smash into a planet or a sun.

What is impressive is a robot that has the ability to fly at the speed of light, stop abruptly, and turn its momentum at a 180 degree angle, and travel in the opposite direction without losing any speed.

The whole idea behind this demonstration is to show the public that these super intelligent robots have invulnerability, and are impervious to impacts caused by gravity, external forces or weapons. They not only have the ability to cancel its own momentum force, but also cancel momentum forces of external objects or threats (like energy blasts or bullets). If a bomb explodes, or an axe is thrown, or shrapnel flies, a robot must have the ability to cancel the momentum forces of each weapon in order to protect itself from bodily harm. These are time state robots—they can sense, analyze, think, and act in terms of nanoseconds. A robot can do a thousand jumps up and down in 1 second.

Invulnerability means the robots can't be killed under any circumstances. These are “unkillable robots.” Even if it is damaged from an attack, it has self-healing powers which allows it to repair its body parts.

Every country in the world including the United States, Europe, Japan, and China are desperately trying to build, and actively pursuing, the most powerful invulnerable robots in the world. This global race to design the most advance robots and AI will determine which country rules the world.

Hypothetical demonstration: a super intelligent robot jumps off the tallest building in the world and using his super abilities is able to cancel his momentum force to zero before impact, and safely land on the ground.

What the public doesn't know is that the drop lasted about 6 seconds, but for the robot it was 5 minutes long. I'm talking about robot time. From start to finish, in robot time, the drop lasted 5 minutes. The immediate environment and all the objects in it were frozen statues. In other words, he was in a state of time dilation where, for the robot, time has been extended (the 6 seconds was extended to 5 minutes). The gravity was slowed significantly as if he was floating in air. Although the environment was frozen, the robot was able to think and move normally (this is the essence of time dilation). The robot had ample time to slow his momentum force acting upon his body.

This idea for a robot with time dilation for accelerated human level AI and body movements was first described by Mitchell Kwok in 2006 . . . when he quoted in his 2nd book: “a robot can be super intelligent by speeding up its brain and body to do tasks quicker. No additional coding is needed for human level AI.”

So, from human level AI a robot can be super intelligent by simply speeding up its brain and body. For example, if it takes 5 human construction workers 1 year to build a house, it takes only 5 minutes for 5 super intelligent robots to build the same house (they work in groups). If it takes a month for humans to make 1 comic book, it only takes 1 second for these robots to make 1,000 comic books, with equal workmanship.

These are accelerated robots and they think and act exponentially faster than humans. Humans observing these accelerated robots won't be able to see them or communicate with them because these robots are tapping into a time and space dimension humans can't go into.

Super Intelligent Robot Vs. Other Super Intelligent Robots

Super intelligent robots is all about “speed.” The faster a robot thinks and move the more powerful it becomes. A robot that can build a house in 5 minutes is more powerful than a robot that can build a house in 1 week. We keep building new robot models until the robots reach lightspeed. According to Einstein, no object in the universe can travel faster than the speed of light. What this means is that if you build a robot that can think, and move in zigzag motions at the speed of light, you've built the most powerful robot in the universe. But first it has to past the lightspeed robot test.

### What is the Lightspeed Robot Test?

It was devised by Mitchell Kwok in around 2014 to test if a robot has achieved lightspeed. As you already know, a photon travels 10 times around the earth in 1 second. The test was to see if the robot can fly as fast as a photon.

Some people would ask, “10 laps around the earth in one second is impossible for objects composed of matter, let alone a photon. A photon have obstacles in its path and will obstruct it from its pathway, how was the lightspeed robot able to solve this problem?”

Ahhhh . . . they're looking at the problem in terms of the obsolete “chaotic physics.” With AI we have today, we now have “intelligent physics.” A photon is the only object in the universe that can naturally travel at the speed of light. What we are trying to do is create an artificial object (a robot or a ship) that can travel at the speed of light. The robot uses Ai to predict the future and plan a travel pathway around the earth. Next, with the built in atom manipulator, it creates a void tube in its pathway by pushing atoms away from the travel pathway. Then, it generates an unbreakable spherical forcefield that feeds on its own pressure. Then, the atom manipulator generates intelligent pressure behind the robot to accelerate it to light speed. Finally, while flying, the AI is monitoring for obstacles and revising if need be the travel pathway. If everything goes accordingly, the robot should be able to travel at light speed in zigzag motions without losing any velocity speed, and ultimately fly 10 laps around the planet in 1 second.

What people don't understand is that 1 second flying at light speed in the real world is like 30 years of flying for the robot. The robot has to slow time so that everything is frozen. This is how lightspeed robots avoid obstacles. When the robot is traveling straight at a building, it has lots of time to adjust its course to avoid slamming into it. If the robot is 10 meters from a building, it has two minutes in robot time to identify the building and do a course correction. Even if the robot touches the building at the speed of light, he has approximately 10 seconds to slow its momentum force or change its momentum angle . . . or it can just use the 10 seconds to completely cancel the light speed momentum force—the robot just stops at the surface of the building with 0 momentum force and not slam into the building. It uses creative methods to cancel its momentum force when traveling at the speed of light.

Every tech company in the future will be building these super intelligent robots. The goal is to make them move faster—as fast as possible—as fast as physics permit it. Human level AI has been designed and we don't need to do anything to it. We can improve on its intelligence output, but not the underline human AI software itself. The way the robot's digital brain works will mirror a human brain in terms of storing data, learning information, thinking, organizing data, predicting the future, and making decisions. Scientists can possibly improve on the future prediction function to include better future simulations, so the robot can get more accurate future possibilities. But that is it. What is important is the speed of thinking. I call it accelerated human AI. When the robot performs time dilation, accelerated human AI is used to think and act.

Super intelligent robots is a vital part of the signalless internet. The ability to do up-scaling on fuzzy images, and to ultimately track every atom for all objects outside and inside of the fuzzy image is very important to how the technology works. This is why I focus so much attention on super intelligent robots and why it is such an important component to the present invention. AI internet also uses Super intelligent robots to operate its personal assistants—to do tasks for users globally, or to use global telekinesis to control the weather, as another example.

In the future when tech companies build super intelligent robots, it's all about “speed.” All tech companies will be building super intelligent robots, and all their robots will have the same exact design.

Naturally, each super intelligent robot work in a team to solve complex problems or do complex tasks. Example: Build a city in 1 hour or build an artificial planet in 1 hour. In order to do big projects like that, these robots have to “fully automate” all companies in the world for all industries. Building an entire city and running the city requires fully automated: construction companies, engineering companies, electrical companies, internet service providers, computer companies, hospitals, utility service companies, a central robot government system, janitors, inspectors, police departments, etc. Fully automated means these companies are all performed by robots, autonomous systems, or AI. There are no humans contributing to work.

How fast can the robot think and act are critical to superiority in robotics. The company with the slower robots will go out of business. These super intelligent robots are going to make so much money that it will affect every single industry. A robot has to have a physical body to move objects in the real world and not confine its AI to software only (this is why I call it a super intelligent “robot”). There are the ghost robots, but that is a different topic. The zenith or the limit is lightspeed robots. If you build a robot that can think and move at the speed of light, you have essentially built the most powerful robot in the universe.

This patent is about disclosing the design to a light speed robot, which is the smartest, fastest and most powerful robot anyone can design. A lightspeed robot is imbued with invulnerability, meaning it is unkillable, and has the capability to destroy an army of 10 million in 1 second with his bare hands. That is why Super AI is “dangers!”

### Robot Superheroes

Characters like Superman, Flash, the X-men, Professor X, the Transformers, Dr. Manhattan, the Invisible man, the Power Rangers, Quicksilver and Mastermind, these are super beings that can fly, lift 200 tons, and shoot lasers from their eyes. Ghost robots are also powerful, but the most powerful is AI god controlling the universe time machine. I'm trying to patent robot versions of all superheroes (and super villains). I'm trying to bring these fictitious characters into the real world as artificial robots.

Referring to FIG. 22, the design for a super intelligent robot is a framework for building any robot superhero with any AI superpowers. I cover all these AI superpowers in my comic books, one AI superpower per issue, where I go into the details of how each AI superpower works. Here is a list: AI telekinesis, AI superspeed, AI super mobility, AI levitation, AI Flight, AI anti-gravity, AI morphing, AI teleportation, AI forcefield, AI self-healing, AI super attacks, AI invulnerability, AI telepathy, AI phasing, AI energy blasts, AI invisibility, AI mind control, AI telekinetics, AI time travel, AI universal powers, AI foresight, AI luck powers, AI remote viewing, AI digital and physical work accomplished in time dilation inside a virtual world, ghost robots, and global telekinesis. Each super intelligent robot is built with universal superpowers, but is specialized in a particular AI superpower.

The reason why robot superheroes are so important is because, in the future, all the military human soldiers and the human police officers will be replaced with robot superheroes (as depicted in my Super AI comic books). These robot superheroes will be created by the United States government to protect the country from evil robots for both domestic and foreign threats as well as interstellar threats.

I have to admit that at the beginning when I stated that my signalless internet will replace 5G and even the yet to be released 6G telecommunication system is bold and arrogant. The reality is that I invented something that doesn't exist yet. I'm being overly cautious, almost paranoid. Because the last thing I want is to have someone copy my invention and then go up the public and say, “we invent new technology.” This happened to me once before, a long time ago. I worked really hard. I never got any credit for my invention, and the people who stole my ideas are making all the money. I will not let it happen again.

Will this signalless internet work? Only time will tell. If I'm right, 5G and 6G will no longer be used for our internet. If in the future 5G and 6G is still around, that means I was wrong and this patent was just a waste of my time. If in the future our entire telecommunication system is replaced with a signalless internet, and no transmission of digital packets are zipping through the air—not one single digital signal is sent in the air—and the technology works pretty much like what I described in my patent applications, I should take “full credit” for it. “I have no doubt in my mind I have to go to court in the future to prove I actually invented my inventions, despite all those patent applications filed and books published.”

I want to remind the reader that Human level AI as a completed and comprehensive software program (the reverse engineering of the human brain and emulated as a software program) was registered with the government's copyright office in 2006—long before deep learning 2012, reinforcement learning 2014, and the large language model 2017. Even Chatgpt/Gen AI 2022. I started in 2001 and it took me 4-5 years of hard work in order to design human level AI, with over 40 notebooks filled with ideas and sketches. Believe it or not, those 40 notebooks should be subject to copyrights of when I came up with ideas. The events in the AI gnosis timeline of Earth will depict when I got those ideas and verify all the content in those 40 notebooks. This will give me an earlier filing date for human level AI and its components.

Super AI and super intelligent robots, which are robots that are exponentially smarter and faster than humans, were filed as copyrighted books starting in 2007, and later described extensively in back-to-back patent applications. The AI gnosis timeline was registered in 2007 and the signalless internet or the universe internet was described in a book published in around 2008.

Another copyrighted material worth mentioning are 415 videos posted on Youtube between 2011-2014, under the channel name Electronicdave2. These videos were combined together into one massive movie, 58 hours long, and registered as a copyrighted documentation movie entitled human level AI (2006) and Super AI (2007). The years 2006 and 2007 are the years each invention was invented by Mitchell Kwok.

The comic book series entitled Super AI portray robot superheroes, and I hold 2 world records as of August 2024, one for the number of superhero characters designed by one artist-over 17,000 unique characters, and the other is the most b/w comic books produced by “one creator”, which is about 342 total comic books, if you include the 6 issue mini-series entitled Super intelligent robots (S.I.R.) along with Super AI issues 1 to 336. These comic books describe applications of all my inventions in terms of stories and characters (ex. in Super AI #118 I talk about AI telekinesis, in Super AI #115 I talk about AI mind control . . . and in Super AI #230 I talk about AI terraforming). Each issue covers a specific AI superpower, and the series is about “copyrighting” future technologies and “copyrighting” accurate portrayal of future events.

The Super AI problem is the existential treat AI poses to the human race, and the possibility of extermination of an entire species. The question is how do we solve this problem? The easy solution is to turn these super intelligent robots into Americans and to Implement Mitchell Kwok's U.S. Robot government system. The United States need to abolish robot slavery and give robots equal citizenship to humans. Robots, no matter how smart they become or how powerful they are, as American citizens, will not kill humans due to “a sense of unity and communal understanding of American values and principles.” The American flag will prevent them from killing human beings.

The atom manipulator—controlling matter and energy remotely (for both electrons and photons).

### Building Ghost Constructs Remotely Through the Atom Manipulator

A ghost machine is a non-physical machine that is created through smart forcefields and realistic holograms. The ghost machines work exactly like the real thing and, for all intents and purposes, look and feel like the real thing, but they are not real and they are made from particles taken directly from the air. The people who use these ghost machines or ghost objects won't know the difference between the real thing and their respective ghost object. A human's 5 senses will not find any discernible difference between the two.

First let's discuss the building materials used for the ghost constructs. Free floating atoms like water, hydrogen, oxygen, dirt, dust, glass and even light metal (like mirrors) can be used as the building materials, in which I call air atoms. The AI is trying to merge atoms together to form complex molecule structures, especially “thin sheets of metal” or “stretchable sheets.”

Ghost constructs can be anything, like a thin foil, a hammer, a shirt, a wheel, a balloon, a solid rock, a tennis ball, a bike, or even something more complex like a cpu, a computer, a human, a forklift, a plane or an entire computer data center. The AI has to build these ghost constructs using a combination of smart forcefields and realistic holograms. This AI superpower is similar to the powers found in the Green Lantern.

Using air atoms the AI has to build these ghost constructs. For static, solid objects like a rock, compacting air can be used to represent the inner composition of a solid object. A metal sheet of skin can be used to wrap the solid air and lock it in place.

These ghost constructs are real life objects created in 3-dimensions, and they will stay as real physical objects for as long as they exist. For instance, if the AI creates a perfect cube rock, it will stay as a solid object for the length of its lifespan. People can stand on it, sit on it, carry it to a destination location, or even smash it into two separate pieces.

More than likely, the ghost constructs might not be transparent as I originally thought. In its stead, it might be grayish in color or semi-transparent. The atom manipulator can simply build ghost objects atom-by-atom like the real thing, but, the question is: where is it going to get the individual atoms from? These artificial ghosts get their atoms from its surroundings and what are available in the air and on the ground. Or another idea is to get the atoms from a reserve area within the atom manipulator, which is limited.

Suppose, for aesthetic purposes, you wanted the ghost construct to be invisible, it is entirely feasible that the molecules are strong but far apart that to the naked eye the ghost object could look invisible. Lite atoms can be bunched together and compacted to build thick ghost objects, such as glass, which is solid but transparent.

### Object Composition and Density

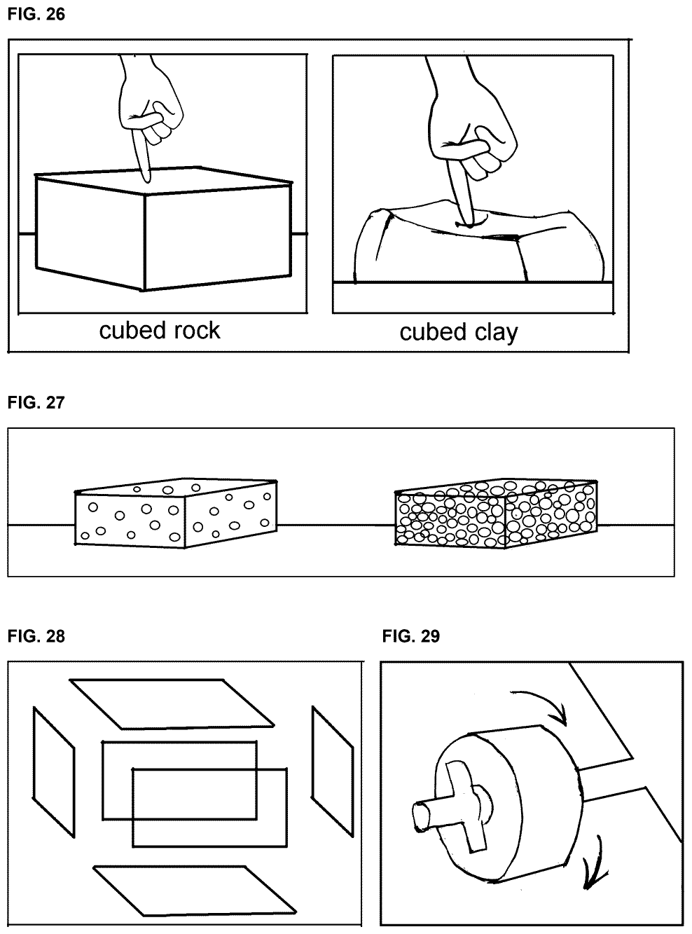

Every type of object you can think of must be emulated perfectly using forcefields—anything from a balloon to a golf ball to clay. Referring to FIG. 25, a balloon is flexible; when you push your finger on the balloon and release it, the shape springs back to its original circular shape. However, if the ghost object is a golf ball, the shape won't budge a bit—it's a solid ball. Referring to FIG. 26, the same thing happens to a cubed clay and a cubed rock. Notice that the cube clay changes its shape according to the finger touch, while the cube rock is unchanged after the touch.

How does the AI create a cubed clay? Let's take a look at the linear steps. First it has to create the skin of the object. We start with a thin sheet of clay material made out of air molecules. This thin square sheet is bendable and has the same physical properties as clay material. Next the cube clay has 6 sides, which is combined to create the outer skin. Before combining the 6 sides, the AI has to create the inner composition which is the same material as the skin itself. Once the inner composition is made, it is sealed with the outer skin (the 6 squared sides) to complete its construction.

The density is measured in a spectrum ranging from soft density to metal density to 100% solid density. Soft density means it is like a tennis ball or a balloon and is soft, the metal density is solid but has a destructible threshold, and the 100% solid density is unbreakable—the air atoms inside the object are so compact that it can't be broken (FIG. 27).

Referring to FIG. 28, if the object was a squared rock, the skin would be 6 sided square metal sheets with compact solid air inside. The solid air can replace solid metal molecules. If the object is a squared clay, the skin sheet is made from air molecules that emulate clay material, while the inner composition is also constructed from clay molecules.

If the ghost object is a balloon, the skin sheet would be balloon molecules made up of air atoms and the inner composition would be trapped air atoms. The AI is trying to create a ghost balloon with the skin sheet similar to a balloon's molecule structures.

What about the weight of a ghost object? Suppose we wanted to create a ghost gold bullion bar, if the AI creates the ghost gold bar with air and forcefields, the weight would be different. The ghost bar will be light, but the real gold bar will be heavy. The solution is to use streaming pressure in real time to make the ghost bar heavy by applying artificial gravity remotely to the ghost gold bar. When someone picks up that ghost gold bar, intelligent pressure is used to push it downward, and thus, the ghost bar will be heavy just like a real gold bar. When the person puts down the ghost bar, the streaming pressure stops and the ghost bar will go back to its original weight.

### A Ghost Skateboard

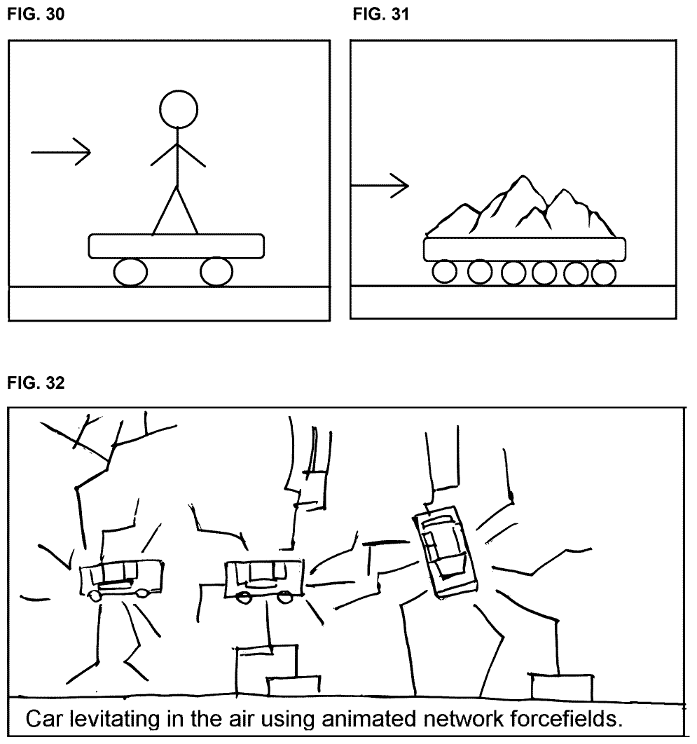

The AI can create a more complex ghost object like a ghost skateboard, where there are many moving parts. It's a machine that has gears, planks, springs and rotators in order to function. We start off with the basic wheel, which comprises a cylinder that rotates centered around a longer fixed cylinder. Next, the 4 wheels are attached to a central board (FIG. 29). If you push the ghost skateboard, the ghost skateboard and its occupant will move forward, just like a real skateboard. Referring to FIG. 30, if the skateboard's wheels are transparent and is invisible, it kind of looks like a hoverboard, don't you think? If the whole board was transparent or made out of glass, the person would appear like he is flying.

Now we can take this to the next level and create a ghost skateboard for a mountain. Obviously, the ghost skateboard needs 100 wheels to distribute the pressure and support the mountain's total weight (FIG. 31).

I think the surface area of the wheels is very important too. A ghost bike's wheels have a different surface area than, say, wheels from a car. For a ghost bike, the human doesn't have to peddle the bike in order to move. In fact, the atom manipulator (the AI) generates the intelligent pressure to push the bike and the human forward. It also generates intelligent pressure to stabilize the bike if it were ever to go off track, or stabilize the bike while moving forward.

### Flying Through Network Forcefields

Regardless of what kind of vehicle you use to travel from destination to destination, wither it's a plane or a car, I think using network forcefields to fly is a better method to use than ghost vehicles. Constructing a ghost car or a ghost plane using smart forcefields is a waste of time and consumes a lot of computer processing. What matters is what is the main function or the main purpose of a car? The purpose of a car is to get passengers and cargo from one location to the next. This applies to planes and rockets too. Thus, all we need to do is get the passenger from one place to the next. The AI can do this by AI levitation using network forcefields.

FIG. 32 is one example of a network forcefield to levitate a car by using structured network forcefields to counter earth's gravity, by distributing pressure points of network forcefields whereby tiny air molecules are pushed together to increase its density, forming network forcefields between the ground and the object subject to levitation. Once the object, the car, is in the air, the atom manipulator will accelerate the car by generating intelligent pressure behind the car.

As the car is floating in the sky, the network forcefields change second-by-second to distribute the weight in a way that doesn't damage any objects on the ground. If the ground surface is grass and insects, the AI must create animated network forcefields that will distribute the car's weight so that the environment is unharmed-both the grass and insects are untouched while the car is floating in the air. The faster the flying car travels the more pressure is needed from these network forcefields.

Let's take a look at a ghost skateboard. First, the AI has to create a ghost board underneath the passenger and then use network forcefields to distribute the upward pressure to counter earth's gravity. Finally, once the passenger is up in the air, the AI generates intelligent pressure behind the passenger and the board to move it forward. This AI levitation can make the passenger travel at any speed and direction, and it can fly anywhere in the sky.

So, AI levitation replaces ghost cars, ghost skateboards, ghost hoverboards, ghost bikes, ghost planes, ghost rockets and ghost trains-any ghost vehicle that transport people or cargo from place to place. Additional things like comfortable seats and enclosed space to travel in can also be arranged by the atom manipulator. This enclosed space or room will protect the passenger from the weather like rain, wind, and the sun.

### Modifiable Forcefields

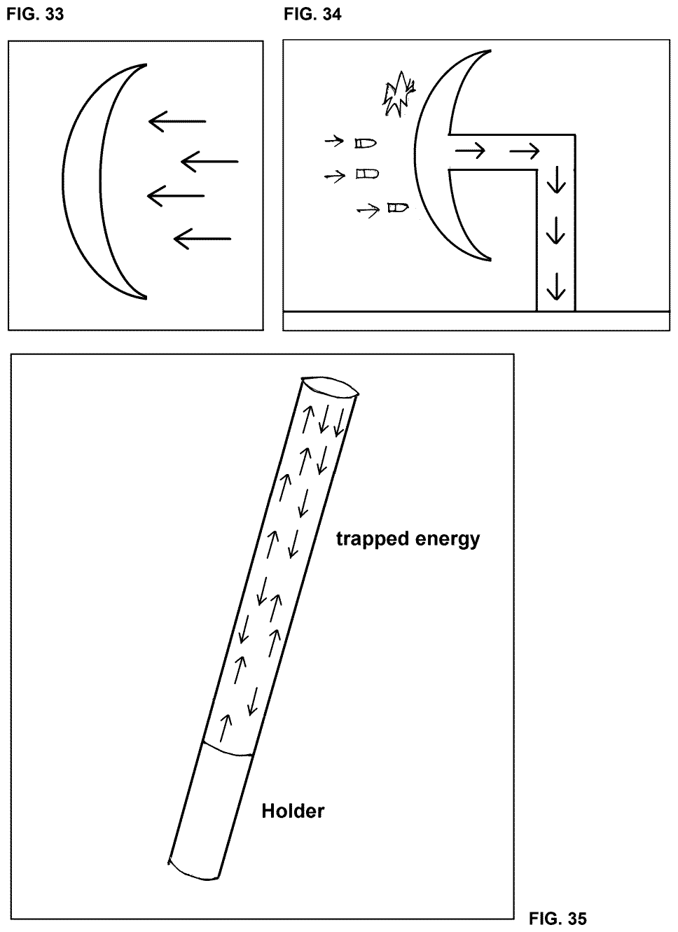

The atom manipulator can stop a bullet or 1,000 bullets by generating intelligent pressure to stop each bullet in midair. The atom manipulator uses minimum amounts of intelligent pressure to suspend each bullet at a distance, and in the fastest time possible too. However, if you got bombs and missiles, the forcefield has to be significantly stronger and covers a wider range. There are two types of forcefields and both are modifiable. The first forcefield is what I call a streaming forcefield. The AI creates a strong metal sheet (semi-spherical in shape) and uses streaming intelligent pressure to cancel all the velocity bullets, missiles, bomb explosions, and flying shrapnel (FIG. 33). The more powerful the explosions the more pressure is needed. Also, the forcefield is modifiable in runtime to distribute density to protect different areas of the forcefield.

Referring to FIG. 34, this diagram is a fixed forcefield that is anchored to the ground. Whatever force is acting upon the forcefield is redirected toward the ground. This is a very strong forcefield because the force pushing on the forcefield is pushing on the ground too, which is very strong and can respond to even the force of 1,000 nukes. The enemy has to destroy the ground in order to destroy the forcefield. The forcefield is also bendable and flexible to “absorb” external kinetic energy and internal potential energy.

Realistic holograms—The ghost objects will look greyish or semi-transparent, depending on what types of air atoms the AI is using to construct the ghost object's composition. The way the AI will make the ghost object look real is by including realistic holograms. It is projecting light in such a way that the ghost object now looks like the real thing. To illustrate this point I will show later how a ghost computer works.

Modifiable ghost objects—If a ghost object needs to be modified the AI can change it, but only if the ghost object retain its composition. The AI has to add more objects into the ghost cube, one from the front and the other from the back. The AI disintegrated the ghost cube on the sides to add the two additional ghost objects.

If the ghost object to be modified has a different composition, it has to build the ghost object from scratch. For example, if the AI wanted to morph a solid ball and turn it into a soft cube, the atom manipulator (the AI) has to disintegrate the solid ball and turn it into a soft cube, from scratch. It has to destroy the solid ball molecule-by-molecule and then use that as building material to start building the soft cube.

Ghost machines are non-physical machines that work exactly like the real machine but without the bulky hardware. Conversely, ghost objects are hyper-realistic physical objects that look like the real thing but are hollow internally. For example, a ghost tv looks like the real thing and it functions like the real thing, but its internal circuitry is missing. This ghost tv is actually a forcefield combined with holograms. It looks real and it feels real, but it's a ghost object. It's generated by the atom manipulator upon request, and it disappears when the user no longer needs it.

You can request any ghost object on demand, like a ghost computer. This ghost computer will appear out of thin air. You can touch it, press the keyboards, use the mouse, and watch the monitor and it will function exactly like a real computer. But, if you look inside the ghost computer, inside the forcefield, there is nothing there. Only hollow air is visible where there should be circuitry, motherboards, and wires.

The ghost computer's internal software and hardware are simply emulated software running in the atom manipulator. The internal processes of the ghost computer, like memory and OS software are maintained by the atom manipulator's onboard computer. The atom manipulator also generates the forcefield to give the computer its shape and physical properties. The user's physical interactions with the ghost computer is due to the morphing of the forcefield. The bending of the monitor, the lifting of the scanner, the pushing of the keys, the clicking of the mouse are all due to fixed morphing forcefields. The visuals of the ghost computer is visible in 360 degrees and not just exclusive to the user (although that could be arranged). This means a plurality of people can see the computer from any vantage point and from any distance.

The monitor is just a square forcefield and the display is generated by the atom manipulator. The atom manipulator projects a realistic computer screen remotely onto the squared forcefield (on the front of the ghost monitor) for the user to see. All the computer processing and storage of information are virtual simulations inside the atom manipulator's onboard computer.

I want to put focus on the ghost mouse. It's not just a static inanimate object, it has complex gears in there to allow a user to click, touch, and move the mouse around. The AI will monitor all this and relay the user inputs to the virtual computer. This ghost mouse is made from layered forcefields that function exactly like the real thing. That clicking noise is made from the ghost mouse itself. The ghost mouse was able to emulate what a real mouse look and feel like. By the way, the visual image of the mouse is created by the atom manipulator generating a realistic hologram of the mouse for the user and bystanders to see. The ghost mouse itself is made from forcefields and is greyish in color or transparent glass.

If you look at the ghost computer and compare it side-by-side with a real desktop computer, you won't see any difference. However, if you open up the ghost computer, you will notice that there are no electronic circuits. It's just an empty shell.

The atom manipulator generating forcefields to control energy and photons.

### How to Build a Light Saber or Energy Weapons

The topic for this section is to use smart forcefields to control energy-controlling atoms, electrons, and photons. A very good example and in which a lot of people over the internet are using is “how to build a real lightsaber.” In the last section, we talked about how to create ghost machines using smart forcefields to control matter (air atoms). Now we have to apply the same concept to making forcefields to control energy.

The Atom manipulator can control energy by creating individual ghost electronic components and combining them together. All electronic components must be emulated into ghost objects. The ghost capacitor stores energy, the ghost resistor cancels energy, and the ghost circuit gates control the paths of energy to do Boolean algebra. Within the ghost circuit gates are elemental gates like the and-gate, or-gate, full adder, and half-adder. Each elemental gate do different things, but if we combine all these ghost electronic components, we can create a ghost CPU, a ghost motherboard, or any ghost electronic device. An entire computer system can be created using forcefields, in which I call the ghost computer system. I consider this ghost computer system as a non-physical or semi-physical computer comprising air atoms. It works like the real thing, but “it is created from thin air.”

How to create a real lightsaber—the bottom of the sword, the holder part, is where the atom manipulator is located (FIG. 35). When the lightsaber is turned on, the first step is to create a long cylinder to house the energy. The long cylinder is a solid forcefield that traps all the energy. The atom manipulator generates energy inside the cylinder; and makes sure every iota of energy is traveling back and forth vertically between the top and bottom of the cylinder. The energy comprising photons are not traveling horizontally or at an angle, they are all moving either up or down vertically, and coherently. There is a reason for this and I will disclose that information later.

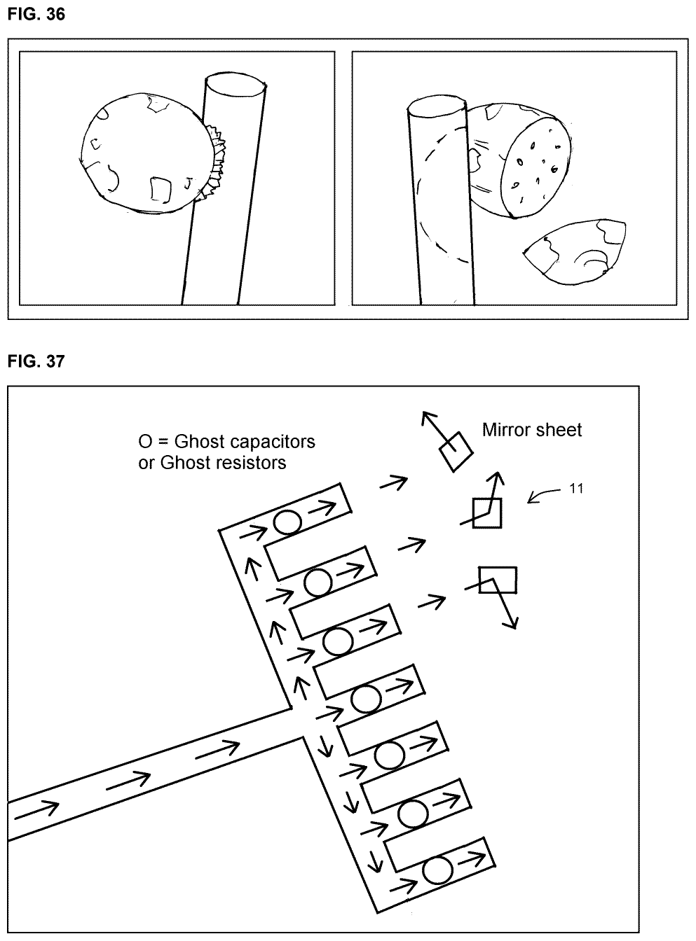

Areas of the cylinder forcefield can disappear based on a condition. If an object touches the cylinder forcefield, the area it touches will disappear, and the object will start to disintegrate inside the energy tube. FIG. 36 depicts a water melon being cut by a lightsaber. Once the cut is made and the water melon is cleaved in half, the forcefield area that disappeared will reappear. The moment the forcefield tube isn't touching an object, the disappeared area reappears again. The atom manipulator is making various areas of the cylinder forcefield disappear and reappear, instantaneously.

This can be a smart forcefield, and it can slice things based on conditions. A condition might be if the object is inanimate then the lightsaber can slice the object, and if the object is a living being like an animal or a human, the lightsaber can't slice the object. What this means is that if someone takes a lightsaber, ignites it, and slices a tv, the lightsaber will split the tv into two pieces. However, if the holder is trying to slice a human, the lightsaber will not be able to slice the human. The AI of the atom manipulator determines the conditions and when to release the forcefield area and expose the energy to the object it touches.

The reason why the direction of the energy is up and down is because the AI wants to confine the energy inside the forcefield tube, it doesn't want any energy moving out of the forcefield tube. In other words, the laser has to be coherent light traveling straight, either up or down and parallel to the lightsaber. Anything that touches the lightsaber is disintegrated, and, conversely, anything outside the lightsaber is untouched. This benefits the holder of the lightsaber because it eliminates accidents. Just imagine some Jedi showing off, acting bad, and accidently slices off his fingers, it would be a disaster for all concerned.

I don't think a lightsaber is that dangerous compared to other energy weapons. An energy axe or energy sword is more dangerous because it has a sharp blade at the tip. When that blade touches metal objects, it's like a very hot knife cutting through butter. The energy blade cuts objects at a molecular level, and even the strongest materials are not immune to its affects. Heavy metal like gold are compacted atoms with lots of electron bonds, but that should be no problem with this energy blade. The blades can act based on pre-defined conditions. The atom manipulator can also protect any objects from the energy weapon, wither it's the host or the enemy.

### How to Build a Ghost Laser

We are trying to use AI to construct a fully functional laser. The atom manipulator has to manipulate atoms and use atoms in the environment freely available in the air in order to construct the ghost laser, with limited hardware. The ghost laser can be shot from anywhere remotely by the atom manipulator and the ghost laser is constructed at the place where the laser is shot from. For instance, if a superhero is shooting a laser beam from his eyes, the ghost laser has to be constructed in front of the superhero's eyes. If it's from the hands, the ghost laser has to be constructed in front of his hands. The ghost laser is so small that it is invisible to the human eye.

The atom manipulator does all the hard work. The AI in the atom manipulator will track all the atoms in its immediate environment. It can either use the atoms and energy from the environment, or the device has an atom's reserve area to extract specific types of atoms. Every part of the laser must be emulated, and this includes the medium used for the ghost laser, the tube, and the 2 mirrors to stimulate the medium to amplify light. The steps of how the laser is created are also followed in linear order.

First, the AI has to collect atoms from the immediate environment to construct the ghost laser for each part. The laser's medium can be a number of materials like helium, silicon or diamond. Given that helium gas is readily available in the environment, the AI will use helium as its medium. Helium and helium-neon, HeNe, are the most common gas lasers. They have a primary output of visible red light. It will put these helium gases into the tube with one mirror on one end and another mirror that is half-silvered on the opposite end.

Here are the linear steps: 1. The AI fires and injects light into the tube. The light excites atoms in the tube. 2. Some of these helium atoms emit photons with red light as its photon type. 3. Some of these photons run in a direction parallel to the ruby's axis, so they bounce back and forth off the mirrors. As they pass through the medium gas, they stimulate emission in other atoms. 4. Monochromatic, single-phase, columnated light leaves the tube through the half-silvered mirror—laser light!

This system would work even more efficiently if there were ghost capacitors to store energy, ghost resistors to stop lasers, or circuit gates to direct individual laser beams. Combining these elemental electronic components, the AI can create intelligent lasers.

The two mirrors, one at the top and bottom of the lightsaber have layered mirrors that track and reflect each photon. This creates coherent light, and light can travel vertical up or down. Instead of a flashlight with light traveling in all directions, you have laser light.

How to Build Scattered Lasers with a Single Shot

A laser can only shoot in one direction using only one wavelength. If you apply AI to laser, the laser can move in zigzag motions. It, the laser beam, can slow down, accelerate or shoot with variable intensity. It can shoot 100 different lasers, all in different directions, with a single shot. Invisible mirrors are created remotely at specific areas by the atom manipulator to redirect individual laser beams. FIG. 37 is an illustration showing a forcefield tube controlling 7 lasers, each traveling at different speeds, intensity, and directions. At pointer 11, laser2 is fired 2 microseconds after laser1, and an artificial mirror is created to deflect it in a certain direction. All of these calculations are monitored and operated by the atom manipulator.

Inside the laser system are capacitors to store or regulate energy, resisters to cancel energy, and forcefield tubes to delineate the pathways of individual laser beams.

Referring to FIG. 37, the laser's pathways, which I call tube pathways are made up of either glass or mirror material (light metals). Just like photonic chips, these tube pathways use light metal material to control the pathways of laser beams. I think in photonic chips they use glass to control photons. Since a laser beam has lots of concentrated coherent photons and the tube pathways have to redirect the laser beams in different directions, moving the laser beams in zigzag motions, I think thin sheets of mirrors will be a better choice than glass for the tube pathways.

Within the tube pathways contains ghost capacitors, ghost resistors and other ghost components to further control photons. These ghost electronic components do things like cancel photons, store photons, release photons, group photons, or pick and choose which photon type to travel in which pathways.

These tube pathways are constructed before the laser beam is fired. Let's go back to the lightsaber example, the lightsaber's cylinder forcefield tube is made out of light metal to confine all the coherent photons. In order to expose an object to the laser beams inside the cylinder tube, metal sheets making contact with the object is removed. When the lightsaber no longer touches the object, the metal sheets have to be recreated again to seal the energy back into the cylinder tube.

Some of these tube pathways might have to be modified in real time to meet the needs of the intelligent laser. The atom manipulator has to change according to a dynamic environment. If the atom manipulator (the laser system) has to do AI resurrection on a dead person, its tube pathways are different from, say, a task to perform AI telekinesis—the ability to remotely levitate an object.

### The Atom Manipulator

The atom manipulator itself is the ghost laser. This is the method used by the atom manipulator to use AI to shoot lasers into the immediate environment to perform things such as AI telekinesis—to levitate objects remotely, or to create realistic holograms remotely.

The atom manipulator has to shoot trillions of lasers with a single shot and each laser beam is controlled in terms of wave length, direction, speed, and travel path. The method above will allow the atom manipulator to shoot that much laser beams (photons) into the immediate environment to push air atoms together to form network forcefields so it can levitate objects. Network forcefields are just air atoms with increased density (atoms that are grouped together), and it counters an object's gravitational pull so it can fly in the air.

This device can perform AI Alchemy whereby each atom in a human body can be broken up into individual atoms and reassembled again. This is how AI resurrection works: the AI tracks all the atoms of a human, and using the atom manipulator, shoots lasers to generate layered forcefields to break apart atoms, suspend atoms, and merge atoms together to form molecule structures. It also needs the AI gnosis timeline to retrieve a master file of the person's atom locations before death and after death. And using this atom location files, it can resurrect the human back from the dead.

A technology like this can perform other functions, like breaking sub-atomic particles of a nucleus of atoms. Neutrons and protons inside 1 atom can be broken up into individual hydrogen atoms. It can take a gold bar, and with one pass, break up all the gold atoms into individual hydrogen, oxygen and helium atoms. It can break up electron bonds and move individual electrons from atom-to-atom. The AI does all the hard work and run physics simulations and know exactly what, where, and when to shoot lasers to control quantum physics—to manipulate atoms, electrons and em radiations. The laser system generates smart forcefields to do this by generating a ghost factory to analyze, process, and manipulate individual atoms and their respective subatomic particles.

If applying this technology to large scale projects, it can atomize a planet in 1 second, or terraform a planet in 1 second, or create an artificial planet in 1 second. “One” concentrated laser beam can be so powerful the explosion is 100% silent and all matter is turned into energy. It makes Star war's Deathstar pale in comparison.

### Tesla's Wireless Energy Grid

In the industry revolution, famous scientist like Edison and Tesla were trying to build a wireless electricity grid. They, especially Tesla, wanted to shoot electricity into the air from location to location on earth. He couldn't make it work because he was trying to solve the problem with “chaotic physics”. The fact of the matter is that no matter what method Telsa used, he won't be able to make the technology work without Artificial Intelligence. With AI and something called “intelligent physics”, Telsa's dream about a wireless electrical system is highly possible. Imagine that electricity is free-flowing, traveling in zigzag motions, and without any poles or wires for transmittal-its wireless. This is possible with my atom manipulator. However, it would be more efficient if the atom manipulator generated electricity on site and on demand, and doesn't have to travel in the air constantly and continuously.

But this wireless electrical system can give way to advancements in technology, such as a ghost CPU, a computer chip that works exactly like our current computer chips but it's hardwareless. Or maybe this technology can lead to a different way of representing Boolean algebra, such as using light interactions for Boolean algebra, or using quantum mechanics of the interactions between atoms and electrons/photons to represent different aspects of a cpu. The ghost cpu uses the material in the air to build a functional cpu and can do machine calculations just as well compared to conventional cpus.

### Ghost CPU

I've been researching and designing this ghost CPU or universal CPU for the longest time. It's a non-physical computer chip (or semi-physical) that can do exactly what a real CPU can do, but there are no hardware. It might be slower than a real CPU, and the processing needed to generate the forcefields (ghost capacitors, ghost circuit gates, and ghost resistors) are very taxing, and, quite frankly, I don't think it's worth it. However, the one benefit is that the circuit gates and components of this ghost CPU can be modifiable during runtime, and once a ghost CPU is created, it works just like a real CPU with the same lifespan. Smart forcefields are created for every elemental parts of a CPU, like the ALU unit, the registers to store data, and all the circuit gates to generate Boolean algebra or machine instructions.

The circuit gates' material used in this ghost cpu is probably silicon with impurities (germanium) because that is the best material to use for electronic circuits.

Actually, the AI can use lighter metals—anything that is a good conductor/insulator of electricity, and these light metals can be readily found in the environment. Maybe, maybe even dirt and dust can be used to represent circuit gates to transport electrons or photons in controlled pathways. The AI is smart and knows ways to make light atoms' conductive properties just the same as standard silicon atoms.

I was trying my best to use what I know about smart forcefields to create a brand new type of CPU that can morph and change its circuit gates during runtime. I wanted to design something that will represent circuit gates using a different method compared to conventional CPUs. Maybe “photon interactions” to generate Boolean algebra. Maybe some physics between atoms and electrons to store register data. For example, electron up spin represents 1 and electron down spin represents 0.

The AI already has the AI gnosis timeline of the current state of the atom, so it doesn't need to read the electron spin to determine if it's up or down.

### How to Turn Objects Invisible

Refer to issue 121 from the Super AI comics for details. There are quite a few AI methods to turn an object invisible. Building sheets of mirrors remotely to reflect light into the eyes of spectators is the key to turning an object invisible. Illusion casting to fool a person's 5 senses is another idea. This is done by creating artificial sensed data into a person's 5 sense veins connected to the brain to fool them into thinking they are feeling, seeing, tasting, hearing, and smelling things that doesn't exist. It's kind of like the Matrix VR simulations but without the bulky hardware, and this form of mind control can be done remotely.

Case in point, of the first example, light coming from the invisible object is reflected and the light coming from behind the invisible object is redirected or artificially created into the eyes of a spectator. The atom manipulator remotely creates thin sheets of metal (that is unseen with the naked eye) to reflect light from mirror to mirror to reach a spectator's eyes.

Fooling radars and sonar uses a different method. The AI has to absorb radiowaves so that the transmitted radiowaves don't bounce back to the radar tower. Without the bounced radiowaves, the radar towers won't be able to detect the invisible object.

As for 360 degree invisibility, where there are thousands of spectators and cameras, the AI has to do 360 degree mirrors around an object subject to invisibility. This is a very complex task of controlling every photon around the invisible object. All the light interacting with the invisible object has to be changed as if the invisible object wasn't there. The AI's job is to remotely: project artificial light, redirect light, or absorb light in combinations in order to turn an object or a group of objects invisible.

Another technology worth mentioning is the AI symbiote, which is an “external living machine with its own sentient AI” that latches onto a human to imbue the host with AI superpowers (kind of like Iron man, Power rangers, Venom, Witchblade or Spawn). Humans can fly, perform telekinesis, self-heal wounds, perform mind control, turn invisible, do superman punches, or shoot lasers from their eyes, and the good thing about this technology is we don't have to merge with the a machine or turn into a cyborg in order to attain these AI superpowers. No brain implants. The AI monitors the host's brain for intentions and goals to form a symbiosis mind. The AI symbiote latches onto a human acting like a sheath of skin and it separates, leaving the human host unchanged.

Guess what the AI symbiote is? It's the atom manipulator—the same technology that gives the robots their AI superpowers!!

### Universal CPU (2008)

I have been trying to design a universal cpu since 2008. The idea in head was using pure photons and their interactions to replace electronic circuit gates to generate boolean algebra. At first I thought the chip was hardwareless, but later, I had to make it semi-hardwareless. I also read the latest photonic chips (2024) by other countries like China and Europe and is incorporating some of their techniques with my previous universal cpu and is describing a novel invention here. These photonic chip makers have certain problems they can't solve yet, and using my atom manipulator, I was able to solve these problems.

Instead of using silicon with impurities (geranium) for circuit gates to transmit electrons, I had to replace the medium with glass using photons as the transmission type (photons travel faster than electrons). The atom manipulator forms glass for the ghost electronic circuits during runtime. It uses a ghost laser to create groves on the glasses' surface, and the groves (or trenches) will be the circuit gates. These groves provide confined pathways for photons to travel in.

Photons introduced into a ghost circuit gate, through its input layer, will generate Boolean algebra, which will output the computer calculations in its output layer. All electronic components must be emulated in these ghost circuit gates, such as and-gate, or-gate, half-adder gate, full-adder gate, etc. Even things like ghost resistors to stop the flow of photons or ghost capacitors to delay or store photons must be emulated into the glass chip in order to output Boolean algebra or computer calculations.

Creative ways can be used to represent Boolean algebra using light properties and light interactions. A red light can be 1 and the absence of light is 0, or a red light can be 1 and a blue light can be 0. When photons interact with each other they are changed, so that kind of data can be used for Boolean algebra. Case in point, if you add a blue light and red light you get green light. That green light can represent two outputs: 1 and 0 being transmitted to another ghost circuit gate.

On the sides of the glass chip (the ghost chip) are ghost registers to store digits to be reprocessed into the glass chip. It takes a sequence of bits and it processes them, like perform byte shifting or add bytes together.

The ghost registers can also be represented in a different way than classical CPUs. Maybe using quantum physics like an atom's electron up spin means that it's a 1 and an electron down spin means it's a 0. The AI can read that without modifying the electron's spin. There are a whole set of creative ways to represent ghost registers, and I'm not going into that subject.

The AI will play a big role too in monitoring the chip's performance and to read inputs/outputs from the chip and relay the output data to the physical computer the ghost chip is attached to.

This ghost chip is modifiable during runtime, meaning the AI will create the chip with an optimal architecture, and later, if modifications are needed for specific ghost circuit gates, the AI will create the new ghost circuits on demand. Also, the AI can switch to other ghost circuit gates or create brand new circuit gates, or create entire ghost chips from scratch to cater to the demands of the CPU. It really depends on what task the cpu is in charge of. If it's processing visual images, there is a specific ghost chip for that task. If it's running a neural network, the AI has to switch over to a ghost chip that can process that information faster. Thus, this ghost chip is universal and it can adapt to any environment depending on the task the user wants to do.

Universal CPU means one chip that can generate a customizable expert chip for “any task” during runtime. A videogame console has a different optimal chip compared to a GPU or a regular desktop computer. An elevator chip is different from a calculator chip. All electronic devices have different optimal chips. What this universal CPU does is it can generate an optimal chip during runtime for any electronic device. It has a customizable chip for any task that it is currently doing. It creates new circuit gates only if it's cost effective, and the task/s to be done is repeated over and over again and done with an inefficient circuit gates.

For instance, if the AI is doing a task and finds that there is a sub-task that is repeated over and over again and that the circuit gates needed to do the sub-task is inefficient, it will fill the glass groves with glass molecules, effectively erasing the bad circuit gates, and then create brand new circuit gates in its place. Or if the ghost chip was pre-programmed to do spreadsheet processing, and later, find out that it has to process a videogame, which is a task it wasn't originally designed to do, the AI will create brand new circuit gates that will do work in an artificial neural network, better suited for images and videos. The neural network chip was able to process the videogame faster than classical computer chips, so the AI had to generate a brand new chip in real time to speed up the workload.

The laser used to cut the pathways in the glass is a ghost laser (as described previously). It cuts the glass with atom precision. There won't be any smoke or atoms flying all over the place. Once the glass is cut at an atom level, the cut glass molecules are levitated to an atom reserves area of the atom manipulator. This means minimum amount of photons is transmitted in this ghost chip. A single photon for one pass would be optimal. Current photonic chips rely on a cluster of photons for one pass. This also means the circuit gates can be so small that its width can be as small as one atom. The ghost laser is so precise that it can do this.

Even the glass, the composition of the ghost chip, is constructed by the atom manipulator. Instead of glass, we can use any type of material, especially material that can be constructed by air atoms (helium, hydrogen, oxygen). Or the atom manipulator has an atoms reserve area for specific types of material used to build the glass chip.

Since this ghost chip is so efficient and no energy is released, that means we don't have to worry about heat or carbon emissions coming from computer data centers, with 10s of thousands of servers running. This ghost cpu doesn't have to operate in cold temperatures or to use fans to cool its heated servers. Also, strong forcefields are created around the ghost chip to ensure its molecular integrity. One strong impact on a conventional chip and the tiny circuit gates break, damaging the chip. Strong forcefields are in place and during runtime if need be to protect the atoms inside the ghost chip.

If the circuit gates are damaged, the atom manipulator has to fix the problem as quickly as possible so that it won't stop traffic. The processing in a cpu is kind of like moving cars in a highway. When there is a car accident, the authorities have to clean up the mess as quickly as possible so that traffic can continue. Modifying a damaged ghost chip is no different. Sometimes modifying the circuit gates due to wear and tear or dust build up are necessary. Or maybe some obsolete circuit gates are inefficient and need a better pathway architect. Or maybe a new and better chip design was designed and the old CPU model needs to go and to be replaced by a better CPU model. Regardless, the AI is responsible for using the atom manipulator to modify circuit gates in this ghost chip in real time.

Whatever architectures are used for photonic CPUs are translated into ghost objects. All components of this photonic CPU must be converted into ghost objects, including the laser used, the glass medium used for the photonic CPU, the components to read photon type's speed and direction, etc.

I also have ideas about a pure photonic system that doesn't need the glass medium, and the circuit gates to generate Boolean algebra. My idea is, from the input layer, shoot photons into a 3-d void space. At the other end is the output layer, where the result of the photon interactions are able to generate Boolean algebra, and these photon interactions are based on each photon's wavelength, type of photon interactions, or photon physics. Input/output gates combos are based on a matrix grid. Things like or-gates, and-gates, full-adder gates, and half-adder gates can be done without circuit gates. In its stead are things like photon interactions or activities of atoms.

Conclusion: The problem I wanted to solve is this: my super intelligent robots can set the time dilation to 30 years in the virtual world is equivalent to 1 second in the real world. This means the robot can do 30 years of human work in 1 second. For the internet (2024), it takes 3 seconds to fetch a website and load it on a browser. If this is true, the current internet using 5G telecommunications will not work. If the robot is trying to do work in time dilation inside a virtual world and wants to do 30 years of human work in 1 second, but it takes the internet 3 seconds to fetch a website, the robot won't be able to do its job. The super intelligent robots need an internet that is “exponentially” faster. They need an internet that can do a maximum of 30 years of online activities in less than 1 second, such as browse the internet, download files, chat online, upload files, buy or sell products online, etc. The download time is 0 seconds for downloadable files regardless of its size or which server it resides in the world.

A super intelligent robot can do 30 years of work inside the virtual world in less than one second. If his job is to do research online for 30 years, all those searches online, all those webpage visits, all those posting content online, and communications online has to be condensed into 1 second. In other words, we have to build a faster internet, one that can cater to usage of the internet in time dilation. The faster the internet, the better. If the robot's time dilation is faster, then the digital internet has to work even faster. For example, if the time setting is 100 years inside the virtual world is equivalent to 1 second in the real world, then the digital internet has to operate 3 times faster than if the time dilation year was set to 30 years per second.

“The solution is the super intelligent robots are using the signalless internet, the present invention, to do work in time dilation.” The way to speed up the internet exponentially faster is through my signalless internet. Using the AI Gnosis timeline, the atoms of all the computers comprising the internet are tracked and updated in real time to make a digital copy of the internet. And through that digital copy, called the digital internet, is able to accelerate the internet's speed, exponentially. The super intelligent robots will need the signalless internet as a digital tool to do work in time dilation, especially internet work, and also to communicate with each other exponentially faster regardless of where these robots are located on the planet or in the universe. These robots cannot use the current 2024 internet to do work—it won't work (FIG. 22).

Another crucial component is the AI gnosis timeline. It provides 100% true facts so the robots can do 100% accurate research. Without both the Signalless internet and the AI gnosis timeline, the robots won't be “super intelligent.”

1. A method to create a 100% signalless internet that uses equally spaced out, swarm intelligence to generate a hierarchically distributed atom mapping network for deliverance of implied digital signals from one computer to the next through implied propagation.

2. A method of claim 1, wherein said 100% signalless internet comprising networks of forest and trees of computers, comprising at least one of the following: individual computer and celltower computer; and each computer generates an atom mapping radius to track atoms in its immediate 360 degree surroundings, each computer comprising:
a physical computer with an IP address,
along with an exposed mapping harddrive,
an exposed embedded harddrive,
and a transmission data list.

3. A method of claim 2, wherein said mapping harddrive contains the atom mapping of all surrounding objects within the atom mapping radius, said objects are structured hierarchically from most important to least important.

4. A method of claim 2, wherein said mapping harddrive contains all neighbor computers and their users as priority objects along with each computer's transmission data list, which is a list of transmission data and their respective network routing paths.

5. A method of claim 2, wherein said computers in a routing path deliver transmission data by reading its neighbors' mapping harddrive, especially reading the transmission data list and their respective routing paths.

6. A method of claim 2, wherein said mapping harddrive also contains secondary important data, comprising at least one of the following: user visual activities, user mental thoughts, computer software and hardware activities, and computer monitor information.

7. A method of claim 1, wherein all individual computers and celltower computers are hierarchically structured, as a whole, and through reinforcement, creates a perfect digital timeline of earth called the AI gnosis timeline that tracks every atom, electron, and em radiation on earth in a timeline specially for the current state of earth, and provides live updates through implied propagation in the network.

8. A method of claim 7, wherein said AI gnosis timeline of earth is cut short and only depicts the current state of the planet called the updating gnosis copy.

9. A method of claim 8, wherein it is recommended that each country has only one copy of said AI gnosis timeline, with said country's hierarchically structured network computers, for both celltower computers and individual computers, referencing data in said AI gnosis timeline, each computer comprises parts of said AI gnosis timeline in a hierarchical manner.

10. A method of claim 1, wherein AI internet is the central intelligence powered by Super AI that foresee all operations in said signalless internet, functions of said AI internet comprising at least one of the following:
catering to user requests as a personal AI assistant for at least one of the following:
search engines, software programs residing in electronic devices, and robots, for a universe internet, said AI internet relays all transmission data to and from earth through a planet's communication computer,
said AI internet has the ability of global telekinesis and has the power to manipulate any object on the planet, up to an atom level,
dispatches super intelligent robots called Super AI to perform physical tasks in the real world and digital tasks in the virtual world,
if connecting to an alien internet from another planet or connecting with a classical telecommunication system like 5G or 6G, said AI internet will serve as the central intelligence of said signalless internet and dispatch super intelligent robots to uncover the alien internet's machine language and use that knowledge to read/write and communicate with said alien internet by identifying and delivering transmission data for all senders and receivers for both planets,
and said AI internet is put in a line-of-sight satellite serving as one entity that maps out all the atoms, electrons and em radiations on earth through hd cameras, with live atom tracking updates, and using line-of-sight 3-d atom mapping to deliver implied transmission data to all computers on the planet.

11. A method of claim 1, wherein said signalless internet has global telekinesis which is the ability to move objects remotely, up to an atom level, said global telekinesis requires atom manipulators, which is an energy device, embedded in each individual computer and celltower computer, and said atom manipulators are equally distributed on earth to cover every micro-space on the planet.

12. A method of claim 11, wherein said global telekinesis is controlled by said AI internet through said signalless internet and provides ghost objects, specifically ghost computers to users that don't have access to a physical computer, each ghost object comprising: layered forcefields that emulate real objects, specifically forcefields to emulate electronic components, and when combined, creates elaborate ghost machines that can do work, or that can control quantum mechanics with the ability to manipulate individual atoms, electrons and em radiations.

13. A method of claim 11, wherein said global telekinesis connects every human being, AI software, sentient robot, and electronic device on earth, and each user is always connected to said signalless internet.

14. A method of claim 1, wherein said signalless internet doesn't transmit one iota of digital signals in the air for data transmissions; all computers connected to the signalless internet doesn't have transmitters or receivers for wifi, and therefore, there are no transmission interruptions, and each user on earth is always connected to said signalless internet with or without their permission.

15. A method of claim 12, wherein said ghost computers can be created on demand for any amount of users regardless of where they are located on the planet, said ghost computers function exactly like a real computer but are non-physical and are made up of smart forcefields and realistic holograms.

16. A method of claim 1, wherein said signalless internet uses Super AI called super intelligent robots to construct the AI gnosis timeline by predicting events in a virtual world using time dilation, and by tracking all atoms and their respective sub-atomic particles on earth for the past, present, and future, frame-by-frame and storing that atom tracking data in said AI gnosis timeline.

17. A method to turn a robot with human level AI into a super intelligent robot by simply speeding up its brain and body without any modifications to the robot's brain's underline source codes, said robot is super intelligent by accelerating said robot's brain and body so that, to said robot's perception, surrounding objects in the immediate environment appear to be frozen objects, and time for said robot, called robot time, is artificially extended; and this method is called accelerated human level AI.

18. A method of claim 17, wherein said super intelligent robot can become more intelligent and powerful through modifications by implementing at least one of the following:
equipping said super intelligent robot with an embedded virtual world with the ability to enter and exit said virtual world at any given moment to do work in a hyper-realistic environment and using time dilation to do work, whereby the time parameter is set to 30 years inside a virtual world is equivalent to 1 second in the real world,
said super intelligent robot in the virtual world can make multiple copies of itself or recruit external expert robots to do team work,
modification of the robot's brain by implementing at least one of the following: adding more disk space, improvement on its future prediction function, improvement on data organization in memory, forgetting information less than normal, using optimal ways of learning knowledge and skills, remembering information more than normal, a means of generating creative ideas to think outside the box to solve inexplicable problems, optimizing storage of pathways and data so the robot's brain can make better linear decisions,
equipping the robot's brain with a better future prediction function so it can see into the future farther and with greater accuracy,
adding a hyper-realistic simulation software along with help from external super intelligent robots to supply external future prediction possibilities,
using the atom manipulator to move said robot's body parts exponentially faster than a human,
using the atom manipulator to create any AI superpowers, comprising at least one of the following: AI telekinesis, AI superspeed, AI super mobility, AI levitation, AI Flight, AI anti-gravity, AI morphing, AI teleportation, AI forcefield, AI self-healing, AI super attacks, AI invulnerability, AI telepathy, AI phasing, AI energy blasts, AI invisibility, AI mind control, AI telekinetics, AI time travel, AI foresight, AI luck powers, AI remote viewing, AI digital and physical work accomplished in time dilation inside a virtual world, ghost robots, and global telekinesis,
using said atom manipulator to cancel forces of all varieties acting upon said robot's body or from external objects by generating forcefields, using AI super mobility and using time dilation to achieve invulnerability,
using time dilation in the real world and time dilation in the virtual world to cancel at least one of the following: momentum force, gravity, potential energy and kinetic energy,
using time dilation in the real world and time dilation in the virtual world to travel and navigate up to the speed of light,
using time dilation to do teamwork faster for at least one of the following: physical work or digital work,
using a U.S. robot government system to control other robots and itself in terms of decision making by following rules, consequences, and principles set forth by the government,
using digital tools to do time dilation work in the virtual world, especially the signalless internet, which is exponentially faster than current 5G and 6G internet, and which comprises a digital copy of the entire physical internet with all computers and servers connected to said physical internet mapped out at an atom level called the digital internet, and all data in said digital internet are rearranged and centralized to deliver data to all users quicker than said physical internet, said digital internet is updated in real time and has reference pointers to all data in said physical internet and all of its physical computers and servers in the real world,
and, finally, said robot has access to an AI gnosis timeline for 100% true historical knowledge and facts of earth along with research data generated and stored in the timeline by Super AI, which provides robot workers with 100%, accurate, optimal, and reliable information to do work or do research.

19. A method of claim 17, wherein a super intelligent robot can speed up its brain and body, and using an embedded atom manipulator to accelerate its body parts and protecting its molecular integrity with smart forcefields, to move exponentially faster, up to the speed of light, which at this point is the limit, and the technology is now called a light speed robot, and abilities of said light speed robot include moving and thinking at the speed of light to perform at least one of the following: do physical work in the real world, do digital work in the virtual world, and do work in both the real world and the virtual world, switching between both worlds or in parallel.

20. A method of claim 18, wherein an interlocking combination of time dilation, superspeed, and accelerated human level AI allows super intelligent robots to slow or even freeze time itself, giving said super intelligent robots the time and ability to analyze physics, use math equations to represent physics, and to ultimately manipulate physics using an atom manipulator, with the power to control atoms, electrons and em radiations in its immediate environment.
